(19) United States
(12) Patent Application Publication
(10) Pub. No.: US 2024/0244242 A1
(43) Pub. Date: Jul. 18, 2024

(54) Reduced Memory Coding

(71) Applicant: Comcast Cable Communications, LLC, Philadelphia, PA (US)

(72) Inventor: Sébastien Lasserre, Thorigné-Fouillard (FR)

(21) Appl. No.: 18/409,220

(22) Filed: Jan. 10, 2024

Related U.S. Application Data
(60) Provisional application No. 63/438,071, filed on Jan. 10, 2023.

(51) Int. Cl. H04N 19/426; H04N 19/152; H04N 19/597

(52) U.S. Cl. CPC H04N 19/426; H04N 19/152; H04N 19/597

(57) ABSTRACT

One or more methods, apparatuses, computer-readable storage mediums, and systems for implementing coding techniques to reduce the quantity of possible occupancy configurations for a neighborhood of a sub-cuboid. A limitation for implementing such coding techniques may be a large memory footprint. The memory footprint may be reduced by using a simplified tree structure.

### CROSS-REFERENCE TO RELATED APPLICATIONS

This application claims the benefit of U.S. Provisional Application No. 63/438,071 filed on Jan. 10, 2023. The above referenced application is hereby incorporated by reference in its entirety.

### BACKGROUND

An object or scene may be described using volumetric visual data consisting of a series of points. The points may be stored as a point cloud format that includes a collection of points in three-dimensional space. As point clouds can get quite large in data size, sending and processing point cloud data may need a data compression scheme that is specifically designed with respect to the unique characteristics of point cloud data.

### SUMMARY

The following summary presents a simplified summary of certain features. The summary is not an extensive overview and is not intended to identify key or critical elements.

Coding (e.g., encoding, decoding) may be used to compress and decompress a point cloud frame or sequence for efficient storage and transmission. A point cloud coding system may comprise a source device that encodes a point cloud sequence into a bitstream and a destination device that decodes the bitstream. The coder (e.g., the source device or the destination device) may represent the point cloud using an occupancy tree and may split the point cloud into cuboids and sub-cuboids. The quantity (e.g., number) of possible occupancy configurations for a current cuboid, associated with a spatial neighborhood of cuboids, may be quite large. Coding techniques may be used to reduce the quantity (e.g., number) of possible occupancy configurations by using a look-up table of context indices. However, such local coding techniques (e.g., Dynamic Optimal Binary Coders with Update on the Fly) may result in a memory footprint that exceeds the size of cache memory, which may negatively impact non-cache memory traffic. The memory footprint may be reduced by using a simplified tree structure.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example point cloud coding system.

FIG. 2 shows a Morton order of eight sub-cuboids split from a cuboid.

FIG. 3 shows an example of a scanning order for an occupancy tree.

FIG. 4 shows an example neighborhood of cuboids for entropy coding the occupancy of a child cuboid.

FIG. 5 shows an example of a dynamic reduction function (DR) that may be used in dynamic OBUF.

FIG. 6 shows an example method for coding occupancy of a cuboid using dynamic OBUF.

FIG. 7 shows an example of an occupied cuboid that corresponds to a TriSoup node of an occupancy tree.

FIG. 8A shows an example cuboid corresponding to a TriSoup node.

FIG. 8B shows an example refinement to a TriSoup model.

FIG. 9 shows an example of voxelization.

FIG. 10A and FIG. 10B show example cuboids.

FIG. 11A, FIG. 11B, and FIG. 11C show TriSoup edges that may be used to entropy code a current TriSoup edge.

FIG. 12A, FIG. 12B, and FIG. 12C show examples of a simplified OBUF tree.

FIG. 13 shows an example hybrid OBUF tree.

FIG. 14A and FIG. 14B show examples of OBUF memory footprints.

FIG. 15 shows an example OBUF tree and buffer.

FIG. 16 shows an example common buffer shared by OBUF trees.

FIG. 17 shows an example of a leaf-per-leaf tree.

FIG. 18 shows an example buffer.

FIG. 19A and FIG. 19B show examples of OBUF memory footprints.

FIG. 20A and FIG. 20B show example methods for encoding and decoding vertex information of a current edge.

FIG. 21 shows an example computer system that may be used by any of the examples described herein.

FIG. 22 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of point cloud or point cloud sequence encoding or decoding systems. More particularly, the technology disclosed herein may relate to point cloud compression as used in encoding and/or decoding devices and/or systems.

At least some visual data may describe an object or scene using a series of points. Each point may comprise a position in two dimensions (x and y) and one or more optional attributes like color. Volumetric visual data may add another positional dimension to these visual data. For example, volumetric visual data may describe an object or scene using a series of points that each may comprise a position in three dimensions (x, y, and z) and one or more optional attributes like color, reflectance, time stamp, etc. Volumetric visual data may provide a more immersive way to experience visual data, for example, compared to the at least some visual data. For example, an object or scene described by volumetric visual data may be viewed from any (or multiple) angles, whereas the at least some visual data may generally only be viewed from the angle in which it was captured or rendered.

Volumetric visual data may be used in many applications, including augmented reality (AR), virtual reality (VR), and mixed reality (MR). Sparse volumetric visual data may be used in the automotive industry for the representation of three-dimensional (3D) maps (e.g., cartography) or as input to assisted driving systems. In the case of assisted driving systems, volumetric visual data may be typically input to driving decision algorithms. Volumetric visual data may be used to store valuable objects in digital form. In applications for preserving cultural heritage, a goal may be to keep a representation of objects that may be threatened by natural disasters. For example, statues, vases, and temples may be entirely scanned and stored as volumetric visual data having several billions of samples. This use-case for volumetric visual data may be particularly relevant for valuable objects in locations where earthquakes, tsunamis and typhoons are frequent. Volumetric visual data may take the form of a volumetric frame. The volumetric frame may describe an object or scene captured at a particular time instance. Volumetric visual data may take the form of a sequence of volumetric frames (referred to as a volumetric sequence or volumetric video). The sequence of volumetric frames may describe an object or scene captured at multiple different time instances.

Volumetric visual data may be stored in various formats. One format for storing volumetric visual data may be point clouds. A point cloud may comprise a collection of points in 3D space. Each point in a point cloud may comprise geometry information that may indicate the point's position in 3D space. For example, the geometry information may indicate the point's position in 3D space, for example, using three Cartesian coordinates (x, y, and z) and/or using spherical coordinates (r, phi, theta) (e.g., if acquired by a rotating sensor). The positions of points in a point cloud may be quantized according to a space precision. The space precision may be the same or different in each dimension. The quantization process may create a grid in 3D space. One or more points residing within each sub-grid volume may be mapped to the sub-grid center coordinates, referred to as voxels. A voxel may be considered as a 3D extension of pixels corresponding to the 2D image grid coordinates. A point in a point cloud may comprise one or more types of attribute information. Attribute information may indicate a property of a point's visual appearance. For example, attribute information may indicate a texture (e.g., color) of the point, a material type of the point, transparency information of the point, reflectance information of the point, a normal vector to a surface of the point, a velocity at the point, an acceleration at the point, a time stamp indicating when the point was captured, or a modality indicating how the point was captured (e.g., running, walking, or flying). A point in a point cloud may comprise light field data in the form of multiple view-dependent texture information. Light field data may be another type of optional attribute information.

The points in a point cloud may describe an object or a scene. For example, the points in a point cloud may describe the external surface and/or the internal structure of an object or scene. The object or scene may be synthetically generated by a computer. The object or scene may be generated from the capture of a real-world object or scene. The geometry information of a real-world object or a scene may be obtained by 3D scanning and/or photogrammetry. 3D scanning may include different types of scanning, for example, laser scanning, structured light scanning, and/or modulated light scanning. 3D scanning may obtain geometry information. 3D scanning may obtain geometry information, for example, by moving one or more laser heads, structured light cameras, and/or modulated light cameras relative to an object or scene being scanned. Photogrammetry may obtain geometry information. Photogrammetry may obtain geometry information, for example, by triangulating the same feature or point in different spatially shifted 2D photographs. Point cloud data may take the form of a point cloud frame. The point cloud frame may describe an object or scene captured at a particular time instance. Point cloud data may take the form of a sequence of point cloud frames. The sequence of point cloud frames may be referred to as a point cloud sequence or point cloud video. The sequence of point cloud frames may describe an object or scene captured at multiple different time instances.

The data size of a point cloud frame or point cloud sequence may be excessive (e.g., too large) for storage and/or transmission in many applications. For example, a single point cloud may comprise over a million points or even billions of points. Each point may comprise geometry information and one or more optional types of attribute information. The geometry information of each point may comprise three Cartesian coordinates (x, y, and z) and/or spherical coordinates (r, phi, theta) that may be each represented, for example, using at least 10 bits per component or 30 bits in total. The attribute information of each point may comprise a texture corresponding to a plurality of (e.g., three) color components (e.g., R, G, and B color components). Each color component may be represented, for example, using 8-10 bits per component or 24-30 bits in total. For example, a single point may comprise at least 54 bits of information, with at least 30 bits of geometry information and at least 24 bits of texture. If a point cloud frame includes a million such points, each point cloud frame may require 54 million bits or 54 megabits to represent. For dynamic point clouds that change over time, at a frame rate of 30 frames per second, a data rate of 1.32 gigabits per second may be required to send (e.g., transmit) the points of the point cloud sequence. Raw representations of point clouds may require a large amount of data, and the practical deployment of point-cloud-based technologies may need compression technologies that enable the storage and distribution of point clouds with a reasonable cost.

Encoding may be used to compress and/or reduce the data size of a point cloud frame or point cloud sequence to provide for more efficient storage and/or transmission. Decoding may be used to decompress a compressed point cloud frame or point cloud sequence for display and/or other forms of consumption (e.g., by a machine learning based device, neural network-based device, artificial intelligence-based device, or other forms of consumption by other types of machine-based processing algorithms and/or devices). Compression of point clouds may be lossy (introducing differences relative to the original data) for the distribution to and visualization by an end-user, for example, on AR or VR glasses or any other 3D-capable device. Lossy compression may allow for a high ratio of compression but may imply a trade-off between compression and visual quality perceived by an end-user. Other frameworks, for example, frameworks for medical applications or autonomous driving, may require lossless compression to avoid altering the results of a decision obtained, for example, based on the analysis of the sent (e.g., transmitted) and decompressed point cloud frame.

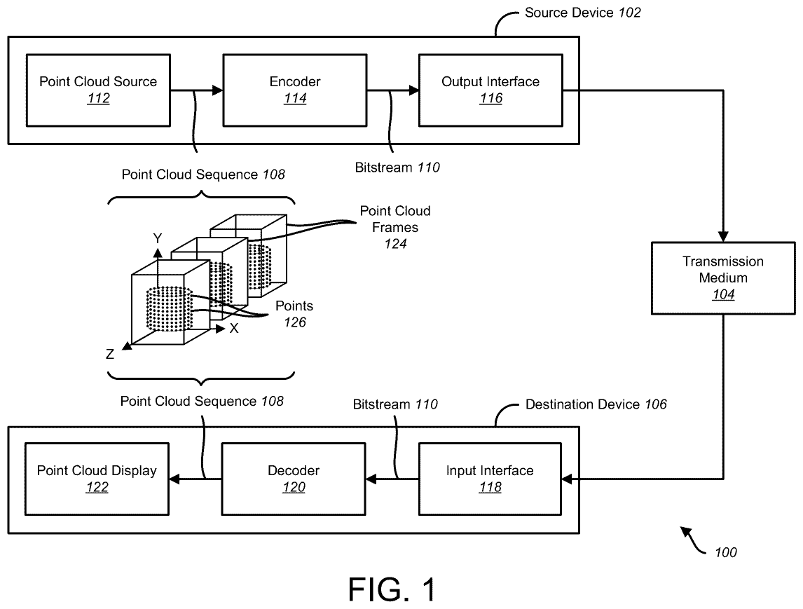

FIG. 1 shows an example point cloud coding (e.g., encoding and/or decoding) system 100. Point cloud coding system 100 may comprise a source device 102, a transmission medium 104, and a destination device 106. Source device 102 may encode a point cloud sequence 108 into a bitstream 110 for more efficient storage and/or transmission. Source device 102 may store and/or send (e.g., transmit) bitstream 110 to destination device 106 via transmission medium 104. Destination device 106 may decode bitstream 110 to display point cloud sequence 108 or for other forms of consumption (e.g., further analysis, storage, etc.). Destination device 106 may receive bitstream 110 from source device 102 via a storage medium or transmission medium 104. Source device 102 and destination device 106 may include any number of different devices. Source device 102 and destination device 106 may include, for example, a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, a vehicle (e.g., an autonomous vehicle), or a head-mounted display. A head-mounted display may allow a user to view a VR, AR, or MR scene and adjust the view of the scene, for example, based on movement of the user's head. A head-mounted display may be connected (e.g., tethered) to a processing device (e.g., a server, a desktop computer, a set-top box, or a video gaming console) or may be fully self-contained.

A source device 102 may comprise a point cloud source 112, an encoder 114, and an output interface 116. A source device 102 may comprise a point cloud source 112, an encoder 114, and an output interface 116, for example, to encode point cloud sequence 108 into a bitstream 110. Point cloud source 112 may provide (e.g., generate) point cloud sequence 108, for example, from a capture of a natural scene and/or a synthetically generated scene. A synthetically generated scene may be a scene comprising computer generated graphics. Point cloud source 112 may comprise one or more point cloud capture devices, a point cloud archive comprising previously captured natural scenes and/or synthetically generated scenes, a point cloud feed interface to receive captured natural scenes and/or synthetically generated scenes from a point cloud content provider, and/or a processor(s) to generate synthetic point cloud scenes. The point cloud capture devices may include, for example, one or more laser scanning devices, structured light scanning devices, modulated light scanning devices, and/or passive scanning devices.

Point cloud sequence 108 may comprise a series of point cloud frames 124 (e.g., an example shown in FIG. 1). A point cloud frame may describe an object or scene captured at a particular time instance. Point cloud sequence 108 may achieve the impression of motion by using a constant or variable time to successively present point cloud frames 124 of point cloud sequence 108. A point cloud frame may comprise a collection of points (e.g., voxels) 126 in 3D space. Each point 126 may comprise geometry information that may indicate the point's position in 3D space. The geometry information may indicate, for example, the point's position in 3D space using three Cartesian coordinates (x, y, and z). One or more of points 126 may comprise one or more types of attribute information. Attribute information may indicate a property of a point's visual appearance. For example, attribute information may indicate, for example, a texture (e.g., color) of a point, a material type of a point, transparency information of a point, reflectance information of a point, a normal vector to a surface of a point, a velocity at a point, an acceleration at a point, a time stamp indicating when a point was captured, a modality indicating how a point was captured (e.g., running, walking, or flying), etc. One or more of points 126 may comprise, for example, light field data in the form of multiple view-dependent texture information. Light field data may be another type of optional attribute information. Color attribute information of one or more of points 126 may comprise a luminance value and two chrominance values. The luminance value may represent the brightness (e.g., luma component, Y) of the point. The chrominance values may respectively represent the blue and red components of the point (e.g., chroma components, Cb and Cr) separate from the brightness. Other color attribute values may be represented, for example, based on different color schemes (e.g., an RGB or monochrome color scheme).

Encoder 114 may encode point cloud sequence 108 into a bitstream 110. To encode point cloud sequence 108, encoder 114 may use one or more lossless or lossy compression techniques to reduce redundant information in point cloud sequence 108. To encode point cloud sequence 108, encoder 114 may use one or more prediction techniques to reduce redundant information in point cloud sequence 108. Redundant information is information that may be predicted at a decoder 120 and may not be needed to be sent (e.g., transmitted) to decoder 120 for accurate decoding of point cloud sequence 108. For example, Motion Picture Expert Group (MPEG) introduced a geometry-based point cloud compression (G-PCC) standard (ISO/IEC standard 23090-9: Geometry-based point cloud compression). G-PCC specifies the encoded bitstream syntax and semantics for transmission and/or storage of a compressed point cloud frame and the decoder operation for reconstructing the compressed point cloud frame from the bitstream. During standardization of G-PCC, a reference software (ISO/IEC standard 23090-21: Reference Software for G-PCC) was developed to encode the geometry and attribute information of a point cloud frame. To encode geometry information of a point cloud frame, the G-PCC reference software encoder may perform voxelization. The G-PCC reference software encoder may perform voxelization, for example, by quantizing positions of points in a point cloud. Quantizing positions of points in a point cloud may create a grid in 3D space. The G-PCC reference software encoder may map the points to the center coordinates of the sub-grid volume (e.g., voxel) that their quantized locations reside in. The G-PCC reference software encoder may perform geometry analysis using an occupancy tree to compress the geometry information. The G-PCC reference software encoder may entropy encode the result of the geometry analysis to further compress the geometry information. To encode attribute information of a point cloud, the G-PCC reference software encoder may use a transform tool, such as Region Adaptive Hierarchical Transform (RAHT), the Predicting Transform, and/or the Lifting Transform. The Lifting Transform may be built on top of the Predicting Transform. The Lifting Transform may include an extra update/lifting step. The Lifting Transform and the Predicting Transform may be referred to as Predicting/Lifting Transform or pred lift. Encoder 114 may operate in a same or similar manner to an encoder provided by the G-PCC reference software

Output interface 116 may be configured to write and/or store bitstream 110 onto transmission medium 104. The bitstream 110 may be sent (e.g., transmitted) to destination device 106. In addition or alternatively, output interface 116 may be configured to send (e.g., transmit), upload, and/or stream bitstream 110 to destination device 106 via transmission medium 104. Output interface 116 may comprise a wired and/or wireless transmitter configured to send (e.g., transmit), upload, and/or stream bitstream 110 according to one or more proprietary, open-source, and/or standardized communication protocols. The one or more proprietary, open-source, and/or standardized communication protocols may include, for example, Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the Internet) or file server(s) configured to store and/or send (e.g., transmit) encoded video data.

Destination device 106 may decode bitstream 110 into point cloud sequence 108 for display or other forms of consumption. Destination device 106 may comprise one or more of an input interface 118, a decoder 120, and/or a point cloud display 122. Input interface 118 may be configured to read bitstream 110 stored on transmission medium 104. Bitstream 110 may be stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary, open-source, standardized communication protocols, and/or any other communication protocol. Examples of the protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Decoder 120 may decode point cloud sequence 108 from encoded bitstream 110. For example, decoder 120 may operate in a same or similar manner as a decoder provided by G-PCC reference software. Decoder 120 may decode a point cloud sequence that approximates a point cloud sequence 108. Decoder 120 may decode a point cloud sequence that approximates a point cloud sequence 108 due to, for example, lossy compression of the point cloud sequence 108 by encoder 114 and/or errors introduced into encoded bitstream 110, for example, if transmission to destination device 106 occurs.

Point cloud display 122 may display a point cloud sequence 108 to a user. The point cloud display 122 may comprise, for example, a cathode rate tube (CRT) display, a liquid crystal display (LCD), a plasma display, a light emitting diode (LED) display, a 3D display, a holographic display, a head-mounted display, or any other display device suitable for displaying point cloud sequence 108.

Point cloud coding (e.g., encoding/decoding) system 100 is presented by way of example and not limitation. Point cloud coding systems different from the point cloud coding system 100 and/or modified versions of the point cloud coding system 100 may perform the methods and processes as described herein. For example, the point cloud coding system 100 may comprise other components and/or arrangements. Point cloud source 112 may, for example, be external to source device 102. Point cloud display device 122 may, for example, be external to destination device 106 or omitted altogether (e.g., if point cloud sequence 108 is intended for consumption by a machine and/or storage device). Source device 102 may further comprise, for example, a point cloud decoder. Destination device 106 may comprise, for example, a point cloud encoder. For example, source device 102 may be configured to further receive an encoded bit stream from destination device 106. Receiving an encoded bit stream from destination device 106 may support two-way point cloud transmission between the devices.

As described herein, an encoder may quantize the positions of points in a point cloud according to a space precision, which may be the same or different in each dimension of the points. The quantization process may create a grid in 3D space. The encoder may map any points residing within each sub-grid volume to the sub-grid center coordinates, referred to as a voxel. A voxel may be considered as a 3D extension of pixels corresponding to 2D image grid coordinates.

An encoder may represent or code a voxelized point cloud. An encoder may represent or code a voxelized point cloud, for example, using an occupancy tree. For example, the encoder may split the initial volume or cuboid containing the voxelized point cloud into sub-cuboids. The initial volume or cuboid may be referred to as a bounding box. A cuboid may be, for example, a cube. The encoder may recursively split each sub-cuboid that contains at least one point of the point cloud. The encoder may not further split sub-cuboids that do not contain at least one point of the point cloud. A sub-cuboid that contains at least one point of the point cloud may be referred to as an occupied sub-cuboid. A sub-cuboid that does not contain at least one point of the point cloud may be referred to as an unoccupied sub-cuboid. The encoder may split an occupied sub-cuboid into, for example, two sub-cuboids (to form a binary tree), four sub-cuboids (to form a quadtree), or eight sub-cuboids (to form an octree). The encoder may split an occupied sub-cuboid to obtain further sub-cuboids. The sub-cuboids may have the same size and shape at a given depth level of the occupancy tree. The sub-cuboids may have the same size and shape at a given depth level of the occupancy tree, for example, if the encoder splits the occupied sub-cuboid along a plane passing through the middle of edges of the sub-cuboid.

The initial volume or cuboid containing the voxelized point cloud may correspond to the root node of the occupancy tree. Each occupied sub-cuboid, split from the initial volume, may correspond to a node (of the root node) in a second level of the occupancy tree. Each occupied sub-cuboid, split from an occupied sub-cuboid in the second level, may correspond to a node (off the occupied sub-cuboid in the second level from which it was split) in a third level of the occupancy tree. The occupancy tree structure may continue to form in this manner for each recursive split iteration until, for example, some maximum depth level of the occupancy tree is reached or each occupied sub-cuboid has a volume corresponding to one voxel.

Each non-leaf node of the occupancy tree may comprise or be associated with an occupancy word representing the occupancy state of the cuboid corresponding to the node. For example, a node of the occupancy tree corresponding to a cuboid that is split into 8 sub-cuboids may comprise or be associated with a 1-byte occupancy word. Each bit (referred to as an occupancy bit) of the 1-byte occupancy word may represent or indicate the occupancy of a different one of the eight sub-cuboids. Occupied sub-cuboids may be each represented or indicated by a binary “1” in the 1-byte occupancy word. Unoccupied sub-cuboids may be each represented or indicated by a binary “0” in the 1-byte occupancy word. Occupied and un-occupied sub-cuboids may be represented or indicated by opposite 1-bit binary values (e.g., a binary “0” representing or indicating an occupied sub-cuboid and a binary “1” representing or indicating an unoccupied sub-cuboid) in the 1-byte occupancy word.

Each bit of an occupancy word may represent or indicate the occupancy of a different one of the eight sub-cuboids. Each bit of an occupancy word may represent or indicate the occupancy of a different one of the eight sub-cuboids, for example, following the so-called Morton order. For example, the least significant bit of an occupancy word may represent or indicate, for example, the occupancy of a first one of the eight sub-cuboids following the Morton order. The second least significant bit of an occupancy word may represent or indicate, for example, the occupancy of a second one of the eight sub-cuboids following the Morton order, etc.

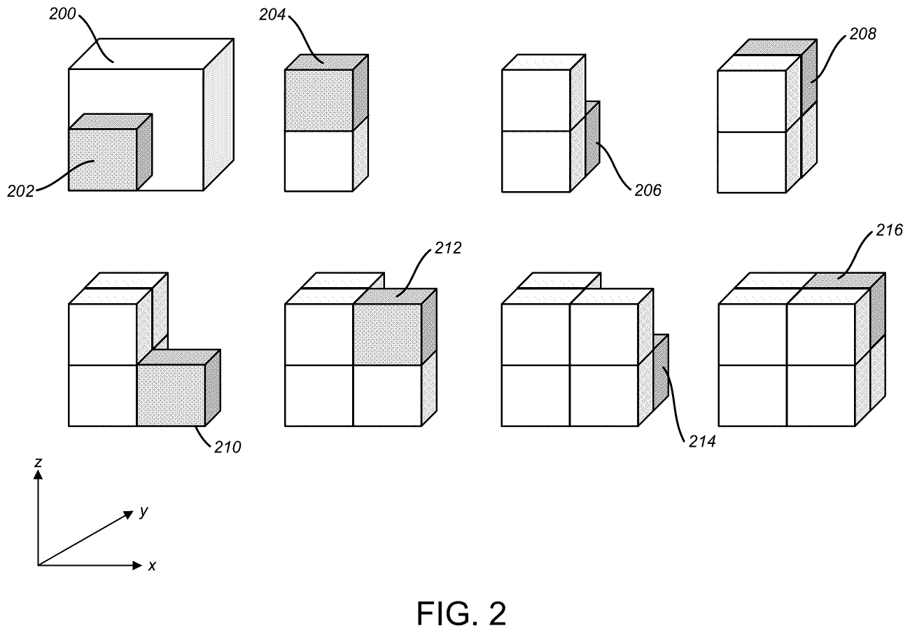

FIG. 2 shows an example Morton order. More specifically, FIG. 2 shows a Morton order of eight sub-cuboids 202-216 split from a cuboid 200. Sub-cuboids 202-216 may be labeled, for example, based on their Morton order, with child node 202 being the first in Morton order and child node 216 being the last in Morton order. The Morton order for sub-cuboids 202-216 may be a local lexicographic order in xyz.

The geometry of a voxelized point cloud may be represented by, and may be determined from, the initial volume and the occupancy words of the nodes in an occupancy tree. An encoder may send (e.g., transmit) the initial volume and the occupancy words of the nodes in the occupancy tree in a bitstream to a decoder for reconstructing the point cloud. The encoder may entropy encode the occupancy words. The encoder may entropy encode the occupancy words, for example, before sending (e.g., transmitting) the initial volume and the occupancy words of the nodes in the occupancy tree. The encoder may encode an occupancy bit of an occupancy word of a node corresponding to a cuboid. The encoder may encode an occupancy bit of an occupancy word of a node corresponding to a cuboid, for example, based on one or more occupancy bits of occupancy words of other nodes corresponding to cuboids that are adjacent or spatially close to the cuboid of the occupancy bit being encoded.

An encoder and/or a decoder may code (e.g., encode and/or decode) occupancy bits of occupancy words in sequence of a scan order. The scan order may also be referred to as a scanning order. For example, an encoder and/or a decoder may scan an occupancy tree in breadth-first order. All the occupancy words of the nodes of a given depth (e.g., level) within the occupancy tree may be scanned. All the occupancy words of the nodes of a given depth (e.g., level) within the occupancy tree may be scanned, for example, before scanning the occupancy words of the nodes of the next depth (e.g., level). Within a given depth, the encoder and/or decoder may scan the occupancy words of nodes in the Morton order. Within a given node, the encoder and/or decoder may scan the occupancy bits of the occupancy word of the node further in the Morton order.

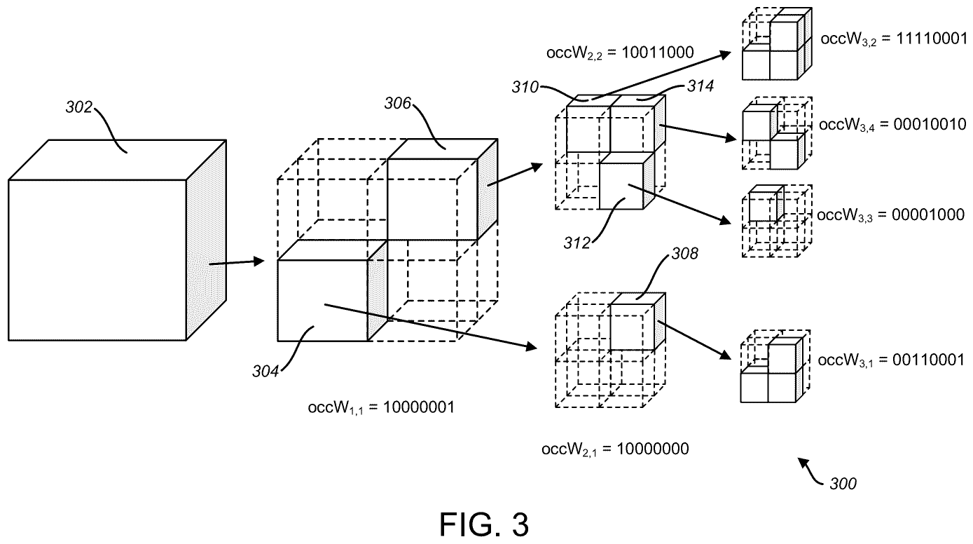

FIG. 3 shows an example scanning order. FIG. 3 shows an example scanning order (e.g., breadth-first order as described herein) for an occupancy tree 300. More specifically, FIG. 3 shows a scanning order for the first three example levels of an occupancy tree 300. In FIG. 3, a cuboid (e.g., cube) 302 corresponding to a root node of the occupancy tree 300 may be divided into eight sub-cuboids (e.g., sub-cubes). Two sub-cuboids 304 and 306 of the eight sub-cuboids may be occupied. The other six sub-cuboids of the eight sub-cuboids may be unoccupied. Following the Morton order, a first eight-bit occupancy word (e.g., occW_{1,1}) may be constructed to represent the occupancy word of the root node. An (e.g., each) occupancy bit of the first eight-bit occupancy word (e.g., occW_{1,1}) may represent or indicate the occupancy of a sub-cube of the eight sub-cuboids in the Morton order. For example, the least significant occupancy bit of the first eight-bit occupancy word occW_{1,1} may represent or indicate the occupancy of the first sub-cuboid of the eight sub-cuboids in the Morton order. The second least significant occupancy bit of the first eight-bit occupancy word occW_{1,1} may represent or indicate the occupancy of the second sub-cuboid of the eight sub-cuboids in the Morton order, etc.

Each of occupied sub-cuboids (e.g., two occupied sub-cuboids 304 and 306) may correspond to a node off the root node in a second level of an occupancy tree 300. The occupied sub-cuboids (e.g., two occupied sub-cuboids 304 and 306) may be each further split into eight sub-cuboids. For example, one of the sub-cuboids 308 of the eight sub-cuboids split from the sub-cube 304 may be occupied, and the other seven sub-cuboids may be unoccupied. Three of the sub-cuboids 310, 312, and 314 of the eight sub-cuboids split from the sub-cube 306 may be occupied, and the other five sub-cuboids of the eight sub-cuboids split from the sub-cube 306 may be unoccupied. Two second eight-bit occupancy words occW_{2,1} and occW_{2,2} may be constructed in this order to respectively represent the occupancy word of the node corresponding to the sub-cuboid 304 and the occupancy word of the node corresponding to the sub-cuboid 306.

Each of occupied sub-cuboids (e.g., four occupied sub-cuboids 308, 310, 312, and 314) may correspond to a node in a third level of an occupancy tree 300. The occupied sub-cuboids (e.g., four occupied sub-cuboids 308, 310, 312, and 314) may be each further split into eight sub-cuboids or 32 sub-cuboids in total. For example, four third level eight-bit occupancy words occW_{3,1}, occW_{3,2}, occW_{3,3} and occW_{3,4} may be constructed in this order to respectively represent the occupancy word of the node corresponding to the sub-cuboid 308, the occupancy word of the node corresponding to the sub-cuboid 310, the occupancy word of the node corresponding to the sub-cuboid 312, and the occupancy word of the node corresponding to the sub-cuboid 314.

Occupancy words of an example occupancy tree 300 may be entropy coded (e.g., entropy encoded by an encoder and/or entropy decoded by a decoder), for example, following the scanning order discussed herein (e.g., Morton order). The occupancy words of the example occupancy tree 300 may be entropy coded (e.g., entropy encoded by an encoder and/or entropy decoded by a decoder) as the succession of the seven occupancy words occW_{1,1} to occW_{3,4}, for example, following the scanning order discussed herein. The scanning order discussed herein may be a breadth-first scanning order. The occupancy word(s) of all node(s) having the same depth (or level) as a current parent node may have already been entropy coded, for example, if the occupancy word of a current child node belonging to the current parent node is being entropy coded. For example, the occupancy word(s) of all node(s) having the same depth (e.g., level) as the current child node and having a lower Morton order than the current child node may have also already been entropy coded. Part of the already coded occupancy word(s) may be used to entropy code the occupancy word of the current child node. The already coded occupancy word(s) of neighboring parent and child node(s) may be used, for example, to entropy code the occupancy word of the current child node. The occupancy bit(s) of the occupancy word having a lower Morton order than a particular occupancy bit may have also already been entropy coded and may be used to code the occupancy bit of the occupancy word of the current child node, for example, if the particular occupancy bit of the occupancy word of the current child node is being coded (e.g., entropy coded).

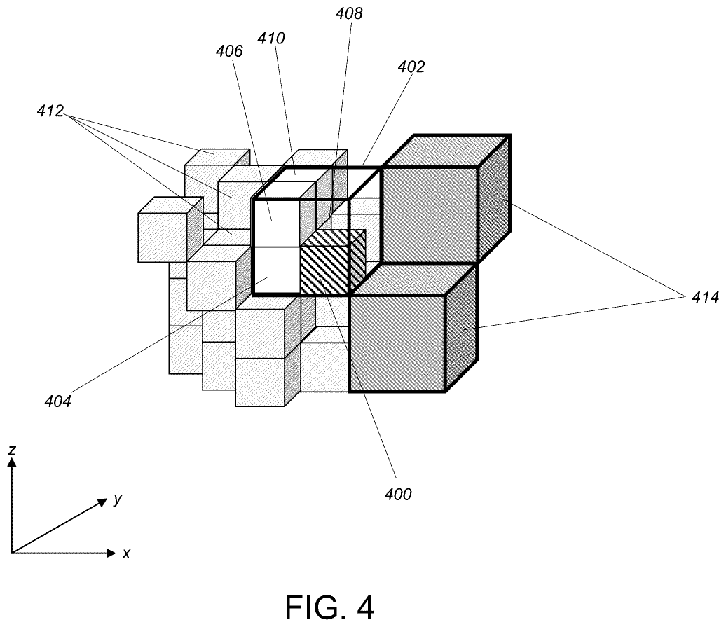

FIG. 4 shows an example neighborhood of cuboids for entropy coding the occupancy of a child cuboid. More specifically, FIG. 4 shows an example neighborhood of cuboids with already-coded occupancy bits. The neighborhood of cuboids with already-coded occupancy bits may be used to entropy code the occupancy bit of a current child cuboid 400. The neighborhood of cuboids with already-coded occupancy bits may be determined, for example, based on the scanning order of an occupancy tree representing the geometry of the cuboids in FIG. 4 as discussed herein. The neighborhood of cuboids, of a current child cuboid, may include one or more of: a cuboid adjacent to the current child cuboid, a cuboid sharing a vertex with the current child cuboid, a cuboid sharing an edge with the current child cuboid, a cuboid sharing a face with the current child cuboid, a parent cuboid adjacent to the current child cuboid, a parent cuboid sharing a vertex with the current child cuboid, a parent cuboid sharing an edge with the current child cuboid, a parent cuboid sharing a face with the current child cuboid, a parent cuboid adjacent to the current parent cuboid, a parent cuboid sharing a vertex with the current parent cuboid, a parent cuboid sharing an edge with the current parent cuboid, a parent cuboid sharing a face with the current parent cuboid, etc. As shown in FIG. 4, current child cuboid 400 may belong to a current parent cuboid 402. Following the scanning order of the occupancy words and occupancy bits of nodes of the occupancy tree, the occupancy bits of four child cuboids 404, 406, 408, and 410, belonging to the same current parent cuboid 402, may have already been coded. The occupancy bit of child cuboids 412 of preceding parent cuboids may have already been coded. The occupancy bits of parent cuboids 414, for which the occupancy bits of child cuboids have not already been coded, may have already been coded. The already-coded occupancy bits of cuboids 404, 406, 408, 410, 412, and 414 may be used to code the occupancy bit of the current child cuboid 400.

The number (e.g., quantity) of possible occupancy configurations (e.g., sets of one or more occupancy words and/or occupancy bits) for a neighborhood of a current child cuboid may be 2, where N is the number (e.g., quantity) of cuboids in the neighborhood of the current child cuboid with already-coded occupancy bits. The neighborhood of the current child cuboid may comprise several dozens of cuboids. The neighborhood of the current child cuboid (e.g., several dozens of cuboids) may comprise 26 adjacent parent cuboids sharing a face, an, edge, and/or a vertex with the parent cuboid of the current child cuboid and also several adjacent child cuboids sharing a face, an edge, or a vertex with the current child cuboid. The occupancy configuration for a neighborhood of the current child cuboid may have billions of possible occupancy configurations, even limited to a subset of the adjacent cuboids, making its direct use impractical. An encoder and/or decoder may use the occupancy configuration for a neighborhood of the current child cuboid to select the context (e.g., a probability model), among a set of contexts, of a binary entropy coder (e.g., binary arithmetic coder) that may code the occupancy bit of the current child cuboid. The context-based binary entropy coding may be similar to the Context Adaptive Binary Arithmetic Coder (CABAC) used in MPEG-H Part 2 (also known as High Efficiency Video Coding (HEVC)).

An encoder and/or a decoder may use several methods to reduce the occupancy configurations for a neighborhood of a current child cuboid being coded to a practical number (e.g., quantity) of reduced occupancy configurations. The 2⁶ or 64 occupancy configurations of the six adjacent parent cuboids sharing a face with the parent cuboid of the current child cuboid may be reduced to nine occupancy configurations. The occupancy configurations may be reduced by using geometry invariance. An occupancy score for the current child cuboid may be obtained from the 2²⁶ occupancy configurations of the 26 adjacent parent cuboids. The score may be further reduced into a ternary occupancy prediction (e.g., “predicted occupied,” “unsure”, or “predicted unoccupied”) by using score thresholds. The number (e.g., quantity) of occupied adjacent child cuboids and the number (e.g., quantity) of unoccupied adjacent child cuboids may be used instead of the individual occupancies of these child cuboids.

An encoder and/or a decoder using/employing one or more of the methods described herein may reduce the number (e.g., quantity) of possible occupancy configurations for a neighborhood of a current child cuboid to a more manageable number (e.g., a few thousands). It has been observed that instead of associating a reduced number (e.g., quantity) of contexts (e.g., probability models) directly to the reduced occupancy configurations, another mechanism may be used, namely Optimal Binary Coders with Update on the Fly (OBUF). An encoder and/or a decoder may implement OBUF to limit the number (e.g., quantity) of contexts to a lower number (e.g., 32 contexts).

OBUF may use a limited number (e.g., 32) of contexts (e.g., probability models). The number (e.g., quantity) of contexts in OBUF may be a fixed number (e.g., fixed quantity). The contexts used by OBUF may be ordered, referred to by a context index (e.g., a context index in the range of 0 to 31), and associated from a lowest virtual probability to a highest virtual probability to code a “1”. A Look-Up Table (LUT) of context indices may be initialized at the beginning of a point cloud coding process. For example, the LUT may initially point to a context with the median virtual probability to code a “1” for all input. The LUT may initially point to a context with the median virtual probability to code a “1”, among the limited number (e.g., quantity) of contexts, for all input. This LUT may take an occupancy configuration for a neighborhood of current child cuboid as input and output the context index associated with the occupancy configuration. The LUT may have as many entries as reduced occupancy configurations (e.g., around a few thousand entries). The coding of the occupancy bit of a current child cuboid may comprise steps including determining the reduced occupancy configuration of the current child node, obtaining a context index by using the reduced occupancy configuration as an entry to the LUT, coding the occupancy bit of the current child cuboid by using the context pointed to (or indicated) by the context index, and updating the LUT entry corresponding to the reduced occupancy configuration, for example, based on the value of the coded occupancy bit of the current child cuboid. The LUT entry may be decreased to a lower context index value, for example, if a binary “0” (e.g., indicating the current child cuboid is unoccupied) is coded. The LUT entry may be increased to a higher context index value, for example, if a binary “1” (e.g., indicating the current child cuboid is occupied) is coded. The update process of the context index may be, for example, based on a theoretical model of optimal distribution for virtual probabilities associated with the limited number (e.g., quantity) of contexts. This virtual probability may be fixed by a model and may be different from the internal probability of the context that may evolve, for example, if the coding of bits of data occurs. The evolution of the internal context may follow a well-known process similar to the process in CABAC.

An encoder and/or a decoder may implement a “dynamic OBUF” scheme. The “dynamic OBUF” scheme may enable an encoder and/or a decoder to handle a much larger number (e.g., quantity) of occupancy configurations for a neighborhood of a current child cuboid, for example, than general OBUF. The use of a larger number (e.g., quantity) of occupancy configurations for a neighborhood of a current child cuboid may lead to improved compression capabilities, and may maintain complexity within reasonable bounds. By using an occupancy tree compressed by OBUF, an encoder and/or a decoder may reach a lossless compression performance as good as 1 bit per point (bpp) for coding the geometry of dense point clouds. An encoder and/or a decoder may implement dynamic OBUF to potentially further reduce the bit rate by more than 25% to 0.7 bpp.

OBUF may not take as input a large variety of reduced occupancy configurations for a neighborhood of a current child cuboid, and may potentially cause a loss of useful correlation. With OBUF, the size of the LUT of context indices may be increased to handle more various occupancy configurations for a neighborhood of a current child cuboid as input. Due to such increase, statistics may be diluted, and compression performance may be worsened. For example, if the LUT has millions of entries and the point cloud has a hundred thousand points, then most of the entries may be never visited (e.g., looked up, accessed, etc.). Many entries may be visited only a few times and their associated context index may not be updated enough times to reflect any meaningful correlation between the occupancy configuration value and the probability of occupancy of the current child cuboid. Dynamic OBUF may be implemented to mitigate the dilution of statistics due to the increase of the number (e.g., quantity) of occupancy configurations for a neighborhood of a current child cuboid. This mitigation may be performed by a “dynamic reduction” of occupancy configurations in dynamic OBUF.

Dynamic OBUF may add an extra step of reduction of occupancy configurations for a neighborhood of a current child cuboid, for example, before using the LUT of context indices. This step may be called a dynamic reduction because it evolves, for example, based on the progress of the coding of the point cloud or, more precisely, based on already visited (e.g., looked up in the LUT) occupancy configurations.

As discussed herein, many possible occupancy configurations for a neighborhood of a current child cuboid may be potentially involved but only a subset may be visited if the coding of a point cloud occurs. This subset may characterize the type of the point cloud. For example, most of the visited occupancy configurations may exhibit occupied adjacent cuboids of a current child cuboid, for example, if AR or VR dense point clouds are being coded. On the other hand, most of the visited occupancy configurations may exhibit only a few occupied adjacent cuboids of a current child cuboid, for example, if sensor-acquired sparse point clouds are being coded. The role of the dynamic reduction may be to obtain a more precise correlation, for example, based on the most visited occupancy configuration while putting aside (e.g., reducing aggressively) other occupancy configurations that are much less visited. The dynamic reduction may be updated on-the-fly. The dynamic reduction may be updated on-the-fly, for example, after each visit (e.g., a lookup in the LUT) of an occupancy configuration, for example, if the coding of occupancy data occurs.

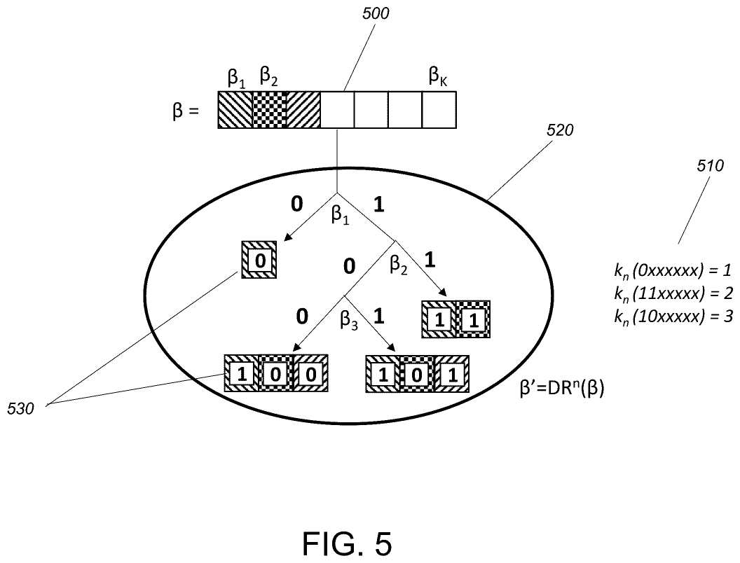

FIG. 5 shows an example of a dynamic reduction function DR that may be used in dynamic OBUF. The dynamic reduction function DR may be obtained by masking bits βⱼ of occupancy configurations 500

$$β = {β}_{1} … {β}_{K}$$

made of K bits. The size of the mask may decrease, for example, if occupancy configurations are visited (e.g., looked up in the LUT) a certain number (e.g., quantity) of times. The initial dynamic reduction function DR⁰ may mask all bits for all occupancy configurations such that it is a constant function DR⁰(β)=0 for all occupancy configurations β. The dynamic reduction function may evolve from a function DRⁿ to an updated function DRⁿ⁺¹. The dynamic reduction function may evolve from a function DRⁿ to an updated function DRⁿ⁺¹, for example, after each coding of an occupancy bit. The function may be defined by

$${β}^{′} = {DR}^{n} ( β ) = {β}_{1} … {β}_{kn ( β )}$$

where kₙ(β) 510 is the number (e.g., quantity) of non-masked bits. The initialization of DR⁰ may correspond to k₀(β)=0, and the natural evolution of the reduction function toward finer statistics may lead to an increasing number (e.g., quantity) of non-masked bits kₙ(β)≤kₙ₊₁(β). The dynamic reduction function may be entirely determined by the values of kₙ for all occupancy configurations β.

The visits (e.g., instances of a lookup in the LUT) to occupancy configurations may be tracked by a variable NV(β′) for all dynamically reduced occupancy configurations β′=DRⁿβ). The corresponding number (e.g., quantity) of visits NV(β^{V}′) may be increased by one, for example, after each instance of coding of an occupancy bit based on an occupancy configuration β^{V}. If this number (e.g., quantity) of visits NV(β^{V}′) is greater than a threshold th_{V},

$$NV ( {β}^{V ′} ) > {th}_{V}$$

then the number (e.g., quantity) of unmasked bits kₙ(β) may be increased by one for all occupancy configurations β being dynamically reduced to β^{V}′. This corresponds to replacing the dynamically reduced occupancy configuration β^{V}′ by the two new dynamically reduced occupancy configurations β⁰′ and β¹′ defined by

$${β}^{0 ′} = {β}^{V ′} 0 = {β}_{1}^{V} … {β}_{kn ( β )}^{V} 0$$

$$and$$

$${β}^{1 ′} = {β}^{V ′} 1 = {β}_{1}^{V} … {β}_{kn ( β )}^{V} 1.$$

In other words, the number (e.g., quantity) of unmasked bits has been increased by one Kₙ₊₁(β)=kₙ(β)+1 for all occupancy configurations β such that DRⁿ(β)=β^{V}′. The number (e.g., quantity) of visits of the two new dynamically reduced occupancy configurations may be initialized to zero

$$NV ( {β}^{0 ′} ) = NV ( {β}^{1 ′} ) = 0. \qquad ( I )$$

At the start of the coding, the initial number (e.g., quantity) of visits for the initial dynamic reduction function DR⁰ may be set to

$$NV ( {DR}^{0} ( β ) ) = NV ( 0 ) = 0 ,$$

and the evolution of NV on dynamically reduced occupancy configurations may be entirely defined.

The corresponding LUT entry LUT[β^{V}′] may be replaced by the two new entries LUT[β⁰′] and LUT[β¹′] that are initialized by the coder index associated with β^{V}′. The corresponding LUT entry LUT[β^{V}′] may be replaced by the two new entries LUT[β⁰′] and LUT[β¹′] that are initialized by the coder index associated with β^{V}′, for example, if a dynamically reduced occupancy configuration β^{V}′ is replaced by the two new dynamically reduced occupancy configurations β⁰′ and β¹′,

$$L U T [ {β}^{0} ’ ] = L U T [ {β}^{1} ’ ] = L U T [ {β}^{V} ’ ] , \qquad ( II )$$

and then evolve separately. The evolution of the LUT of coder indices on dynamically reduced occupancy configurations may be entirely defined.

The reduction function DRⁿ may be modeled by a series of growing binary trees Tⁿ 520 whose leaf nodes 530 are the reduced occupancy configurations β′=DRⁿ(β). The initial tree may be the single root node associated with 0=DR⁰(β). The replacement of the dynamically reduced to β^{V}′ by β⁰′ and β¹′ may correspond to growing the tree Tⁿ from the leaf node associated with β^{V}′, for example, by attaching to it two new nodes associated with β⁰′ and β¹′. The tree Tⁿ⁺¹ may be obtained by this growth. The number (e.g., quantity) of visits NV and the LUT of context indices may be defined on the leaf nodes and evolve with the growth of the tree through equations (I) and (II).

The practical implementation of dynamic OBUF may be made by the storage of the array NV[β′] and the LUT[β′] of context indices, as well as the trees Tⁿ 520. An alternative to the storage of the trees may be to store the array kₙ[β] 510 of the number (e.g., quantity) of non-masked bits.

A limitation for implementing dynamic OBUF may be its memory footprint. In some applications, a few million occupancy configurations may be practically handled, leading to about 20 bits βᵢ constituting an entry configuration β to the reduction function DR. Each bit βᵢ may correspond to the occupancy status of a neighboring cuboid of a current child cuboid or a set of neighboring cuboids of a current child cuboid.

Higher (e.g., more significant) bits βᵢ (e.g., β₀, β₁, etc.) may be the first bits to be unmasked. Higher (e.g., more significant) bits βᵢ (e.g., β₀, β₁, etc.) may be the first bits to be unmasked, for example, during the evolution of the dynamic reduction function DR. The order of neighbor-based information put in the bits βᵢ may impact the compression performance. Neighboring information may be ordered from higher (e.g., highest) priority to lower priority and put in this order into the bits βᵢ, from higher to lower weight. The priority may be, from the most important to the least important, occupancy of sets of adjacent neighboring child cuboids, then occupancy of adjacent neighboring child cuboids, then occupancy of adjacent neighboring parent cuboids, then occupancy of non-adjacent neighboring child nodes, and finally occupancy of non-adjacent neighboring parent nodes. Adjacent nodes sharing a face with the current child node may also have higher priority than adjacent nodes sharing an edge (but not sharing a face) with the current child node. Adjacent nodes sharing an edge with the current child node may have higher priority than adjacent nodes sharing only a vertex with the current child node.

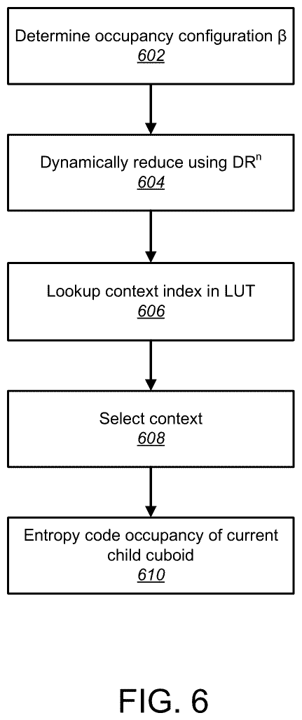

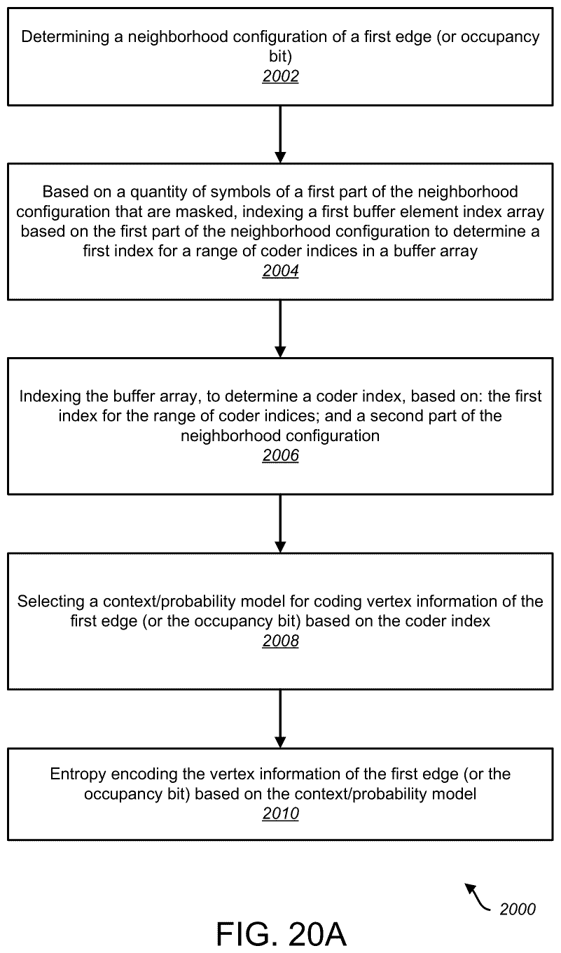

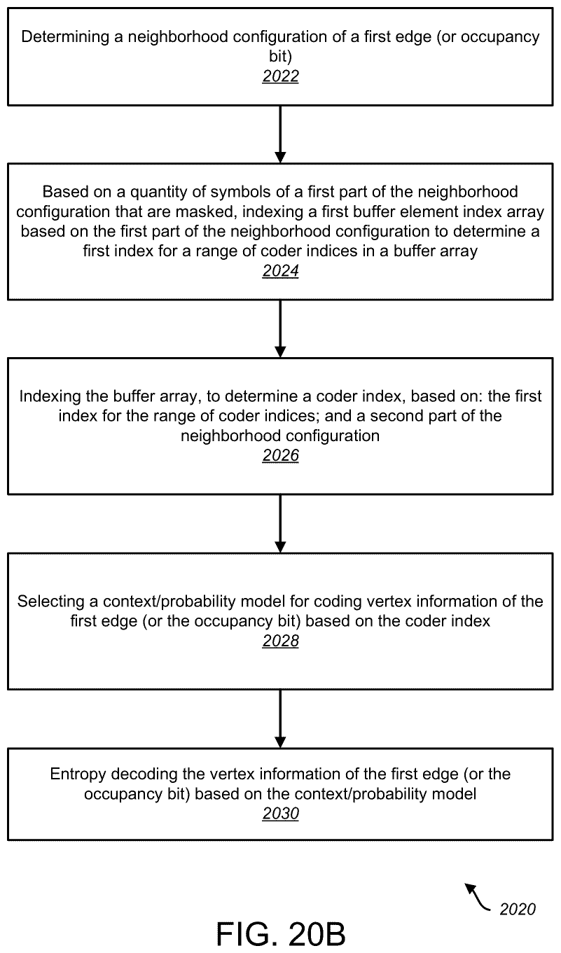

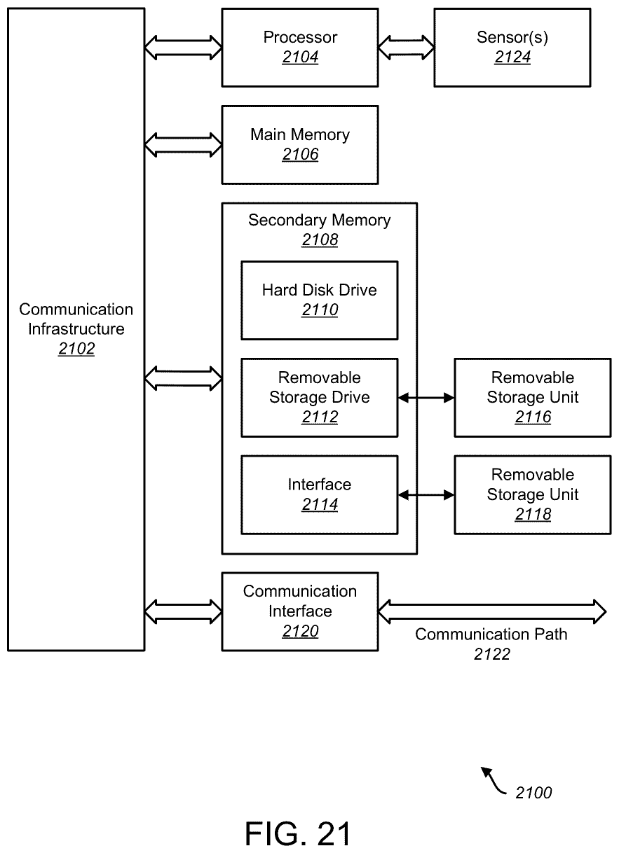

FIG. 6 shows an example method for coding occupancy of a cuboid using dynamic OBUF. More specifically, FIG. 6 shows an example method for coding occupancy bit of a current child cuboid using dynamic OBUF. One or more steps of FIG. 6 may be performed by an encoder and/or a decoder (e.g., the encoder 114 and/or decoder 120 in FIG. 1). All or portions of the flowchart may be implemented by a coder (e.g., the encoder 114 and/or decoder 120 in FIG. 1), an example computer system 2000 in FIG. 20, and/or an example computing device 2130 in FIG. 21.

At step 602, an occupancy configuration (e.g., occupancy configuration β) of the current child cuboid may be determined. The occupancy configuration (e.g., occupancy configuration β) of the current child cuboid may be determined, for example, based on occupancy bits of already-coded cuboids in a neighborhood of the current child cuboid. At step 604, the occupancy configuration (e.g., occupancy configuration β) may be dynamically reduced. The occupancy configuration may be dynamically reduced, for example, using a dynamic reduction function DRⁿ. For example, the occupancy configuration β may be dynamically reduced into a reduced occupancy configuration β′=DRⁿ(β). At step 606, context index may be looked up, for example, in a look-up table (LUT). For example, the encoder and/or decoder may look up context index LUT[β′] in the LUT of the dynamic OBUF. At step 608, context (e.g., probability model) may be selected. For example, the context (e.g., probability model) pointed to by the context index may be selected. At step 610, occupancy of the current child cuboid may be entropy coded. For example, the occupancy bit of the current child cuboid may be entropy coded (e.g., arithmetic coded), for example, based on the context.

Although not shown in FIG. 6, the encoder and/or decoder may update the reduction function and/or update the context index. For example, the encoder and/or decoder may update the reduction function DRⁿ into DRⁿ⁺¹ and/or update the context index LUT[β′], for example, based on the occupancy bit of the current child cuboid. The method of FIG. 6 may be repeated for additional or all child cuboids of parent cuboids corresponding to nodes of the occupancy tree in a scan order, such as the scan order discussed herein with respect to FIG. 3.

In general, the occupancy tree is a lossless compression technique. The occupancy tree may be adapted to provide lossy compression, for example, by modifying the point cloud on the encoder side (e.g., down-sampling, removing points, moving points, etc.). The performance of the lossy compression may be weak. The lossy compression may be a useful lossless compression technique for dense point clouds.

One approach to lossy compression for point cloud geometry may be to set the maximum depth of the occupancy tree to not reach the smallest volume size of one voxel but instead to stop at a bigger volume size (e.g., N×N×N cuboids (e.g., cubes), where N>1). The geometry of the points belonging to each occupied leaf node associated with the bigger volumes may then be modeled. This approach may be particularly suited for dense and smooth point clouds that may be locally modeled by smooth functions such as planes or polynomials. The coding cost may become the cost of the occupancy tree plus the cost of the local model in each of the occupied leaf nodes.

A scheme for modeling the geometry of the points belonging to each occupied leaf node associated with a volume size larger than one voxel may use sets of triangles as local models. The scheme may be referred to as the “TriSoup” scheme. TriSoup is short for “Triangle Soup” because the connectivity between triangles may not be part of the models. An occupied leaf node of an occupancy tree that corresponds to a cuboid with a volume greater than one voxel may be referred to as a TriSoup node. An edge belonging to at least one cuboid corresponding to a TriSoup node may be referred to as a TriSoup edge. A TriSoup node may comprise a presence flag (sₖ) for each TriSoup edge of its corresponding occupied cuboid. A presence flag (sₖ) of a TriSoup edge may indicate whether a TriSoup vertex (Vₖ) is present or not on the TriSoup edge. At most one TriSoup vertex (Vₖ) may be present on a TriSoup edge. For each vertex (Vₖ) present on a TriSoup edge of an occupied cuboid, the TriSoup node corresponding to the occupied cuboid may comprise a position (pₖ) of the vertex (Vₖ) along the TriSoup edge.

In addition to the occupancy words of an occupancy tree, an encoder may entropy encode the TriSoup vertex presence flags and positions of each TriSoup edge belonging to TriSoup nodes of the occupancy tree. A decoder may similarly entropy decode the TriSoup vertex presence flags and positions of each TriSoup edge belonging to a TriSoup node of the occupancy tree, in addition to the occupancy words of the occupancy tree.

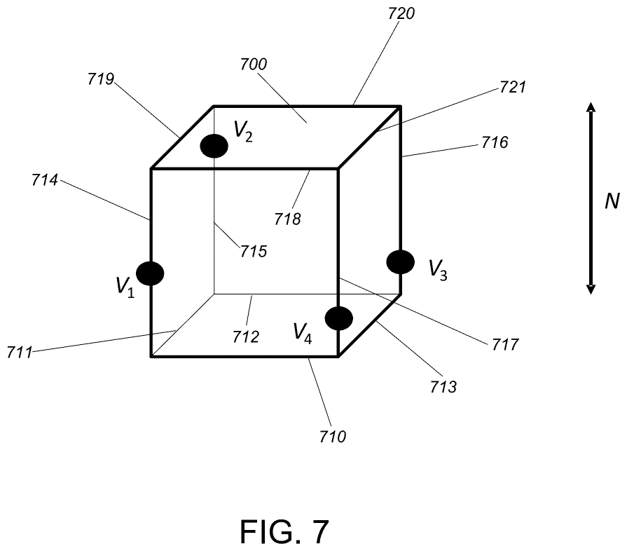

FIG. 7 shows an example of an occupied cuboid (e.g., cube) 700. More specifically, FIG. 7 shows an example of an occupied cuboid (e.g., cube) 700 of size N×N×N (where N>1) that corresponds to a TriSoup node of an occupancy tree. An occupied cuboid 700 may comprise edges (e.g., TriSoup edges 710-721). The TriSoup node, corresponding to the occupied cuboid 700, may comprise a presence flag (sₖ) for each edge (e.g., each TriSoup edge of the TriSoup edges 710-721). For example, the presence flag of a TriSoup edge 714 may indicate that a TriSoup vertex V₁ is present on the TriSoup edge 714. The presence flag of a TriSoup edge 715 may indicate that a TriSoup vertex V₂ is present on the TriSoup edge 715. The presence flag of a TriSoup edge 716 may indicate that a TriSoup vertex V₃ is present on the TriSoup edge 716. The presence flag of a TriSoup edge 717 may indicate that a TriSoup vertex V₄ is present on the TriSoup edge 717. The presence flags of the remaining TriSoup edges each may indicate that a TriSoup vertex is not present on their corresponding TriSoup edge. The TriSoup node, corresponding to the occupied cuboid 700, may comprise a position for each TriSoup vertex present along one of its TriSoup edges 710-721. More specifically, the TriSoup node, corresponding to the occupied cuboid 700, may comprise a position p₁ for TriSoup vertex V₁, a position p₂ for TriSoup vertex V₂, a position p₃ for TriSoup vertex V₃, and a position p₄ for TriSoup vertex V₄.

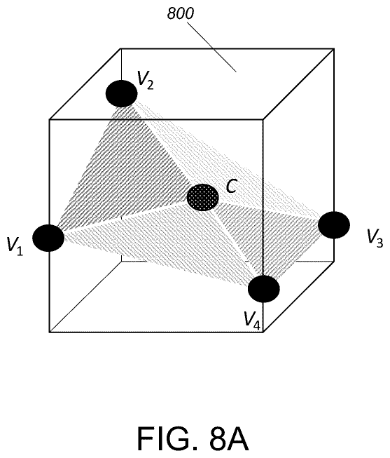

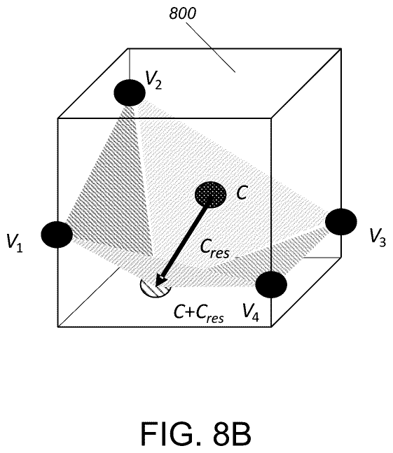

FIG. 8(a) shows an example cuboid (e.g., cube) 800 corresponding to a TriSoup node. A cuboid 800 may correspond to a TriSoup node with a number K of TriSoup vertices Vₖ. Within cuboid 800, TriSoup triangles may be constructed from the TriSoup vertices Vₖ. TriSoup triangles may be constructed from the TriSoup vertices Vₖ, for example, if at least three (K≥3) TriSoup vertices are present on the TriSoup edges of cuboid 800. For example, with respect to FIG. 8(a), four TriSoup vertices may be present and TriSoup triangles may be constructed. The TriSoup triangles may be constructed around the centroid vertex C defined as the mean of the TriSoup vertices Vₖ. A dominant direction may be determined, then vertices Vₖ may be ordered by turning around this direction, and the following K TriSoup triangles may be constructed: V₁V₂C, V₂V₃C, . . . , V_{K}V₁C. The dominant direction may be chosen among the three directions respectively parallel to the axes of the 3D space to increase or maximize the 2D surface of the triangles, for example, if the triangles are projected along the dominant direction. By doing so, the dominant direction may be somewhat perpendicular to a local surface defined by the points of the point cloud belonging to the TriSoup node.

FIG. 8(b) shows an example refinement to the TriSoup model. The TriSoup model may be refined by coding a centroid residual value. A centroid residual value Cᵣₑₛ may be coded into the bitstream. A centroid residual value Cᵣₑₛ may be coded into the bitstream, for example, to use C+Cᵣₑₛ instead of C as a pivoting vertex for the triangles. By using C+Cᵣₑₛ as the pivoting vertex for the triangles, the vertex C+Cᵣₑₛ may be closer to the points of the point cloud than the centroid C, the reconstruction error may be lowered, leading to lower distortion at the cost of a small increase in bitrate needed for coding Cᵣₑₛ.

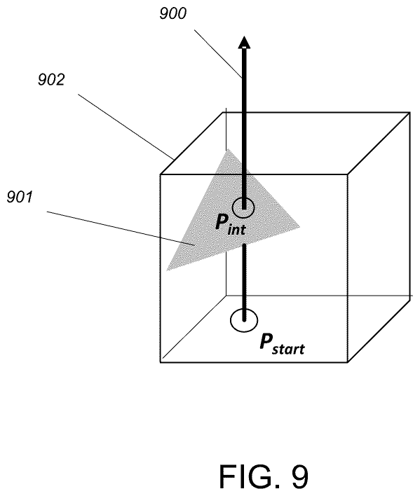

FIG. 9 shows an example of voxelization. Voxelization may refer to reconstruction of a decoded point cloud from a set of TriSoup triangles. Voxelization may be performed by ray tracing for each triangle individually. Voxelization may be performed by ray tracing for each triangle individually, for example, before removing duplicated points between voxelized triangles. As shown in FIG. 9, rays 900 may be launched parallel to one of the three axes of the 3D space. Rays 900 may be launched starting from integer coordinates Pₛₜₐᵣₜ. The intersection Pᵢₙₜ (if any) of the rays 900 with a TriSoup triangle 901 belonging to a cuboid (e.g., cube) 902 corresponding to a TriSoup node may be rounded to obtain a decoded point. This intersection Pint may be found, for example, using the Möller-Trumbore algorithm

A presence flag (sₖ) and, if the presence flag (sₖ) may indicate the presence of a vertex, a position (pₖ) of a current TriSoup edge may be entropy coded. The presence flag (sₖk) and position (pₖ) may be individually or collectively referred to as vertex information or TriSoup vertex information. A presence flag (sₖ) and, if the presence flag (sₖ) indicates the presence of a vertex, a position (pₖ) of a current TriSoup edge may be entropy coded, for example, based on already-coded presence flags and positions of TriSoup edges that neighbor the current TriSoup edge. A presence flag (sₖ) and, if the presence flag (sₖ) may indicate the presence of a vertex, a position (pₖ) of a current TriSoup edge may be additionally or alternatively entropy coded. The presence flag (sₖ) and the position (pₖ) of a current TriSoup edge may be additionally or alternatively entropy coded, for example, based on occupancies of cuboids that neighbor the current TriSoup edge. Similar to the entropy coding of the occupancy bits of the occupancy tree, a configuration β_{TS} for a neighborhood (also referred to as a neighborhood configuration β_{TS}) of a current TriSoup edge may be obtained and dynamically reduced into a reduced configuration β_{TS}′=DRⁿ(β_{TS}), for example, by using a dynamic OBUF scheme for TriSoup. A context index LUT[β_{TS}′] may be obtained from the OBUF LUT. At least a part of the vertex information of the current TriSoup edge may be entropy coded using the context (e.g., probability model) pointed to by the context index.

The TriSoup vertex position (pₖ) (if present) along its TriSoup edge may be binarized. The TriSoup vertex position (pₖ) (if present) along its TriSoup edge may be binarized, for example, to use a binary entropy coder to entropy code at least part of the vertex information of the current TriSoup edge. A number (e.g., quantity) of bits N_{b} may be set for the quantization of the TriSoup vertex position (pₖ) along the TriSoup edge of length N. The TriSoup edge of length N may be uniformly divided into 2^{Nb} quantization intervals. By doing so, the TriSoup vertex position (pₖ) may be represented by N_{b} bits (pₖ^{j}, j=1, . . . , N_{b}) that may be individually coded by the dynamic OBUF scheme as well as the bit corresponding to the presence flag (sₖ). The neighborhood configuration β_{TS}, the OBUF reduction function DRⁿ, and the context index may depend on the nature of the coded bit (e.g., presence flag (sₖ), highest position bit (pₖ¹), second highest position bit (pₖ²), etc.). There may practically be several dynamic OBUF schemes, each dedicated to a specific bit of information (e.g., presence flag (sₖ) or position bit (pₖ^{j}) of the vertex information.

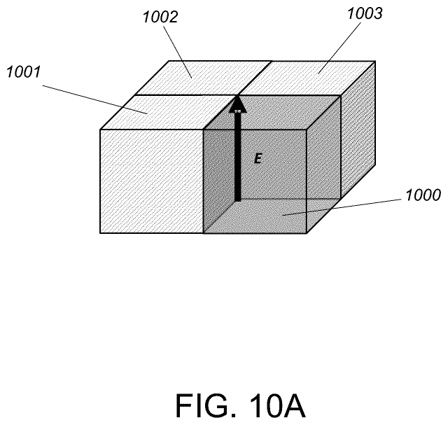

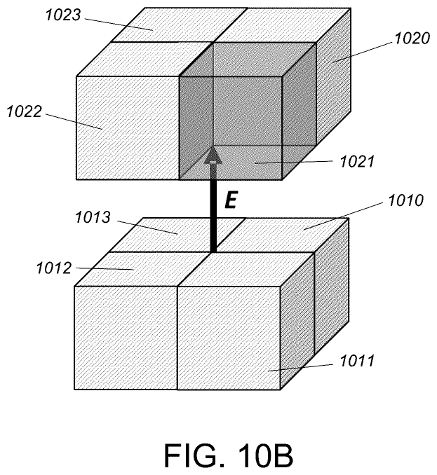

FIG. 10(a) and FIG. 10(b) show example cuboids. More specifically, FIG. 10(a) and FIG. 10(b) show 12 cuboids 1000-1003, 1010-1013, and 1020-1023 with volumes that intersect a current TriSoup edge E being entropy coded. The current TriSoup edge E may be an edge of cuboids 1000-1003. A start point of the current TriSoup edge E may intersect cuboids 1010-1013. An end point of the current TriSoup edge E may intersect cuboids 1020-1023. The occupancy bits of one or more of the 12 cuboids 1000-1003, 1010-1013, and 1020-1023 may be used to determine a neighborhood configuration β_{TS} for the current TriSoup edge E.

TriSoup edges may be oriented from a start point to an end point following the orientation of one of the three axes of the 3D space that the edges are parallel to. A global ordering of the TriSoup edges may be defined as the lexicographic order over the couple (e.g., start point, end point). Vertex information related to the TriSoup edges may be coded following the TriSoup edge ordering. A causal neighborhood of a current TriSoup edge may be obtained from the neighboring already-coded TriSoup edges of the current TriSoup edge.

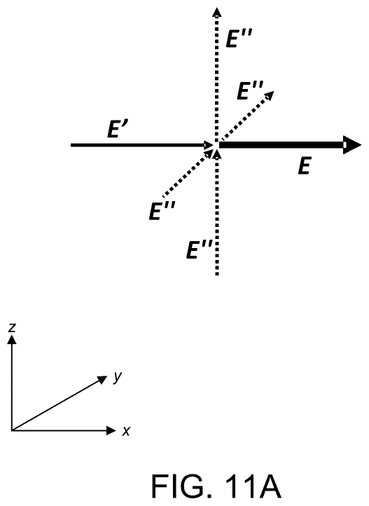

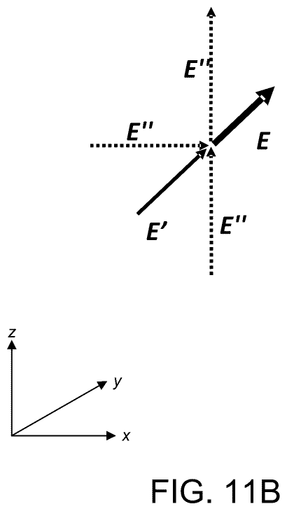

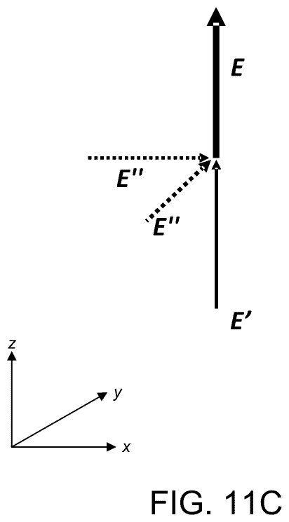

FIG. 11(a), FIG. 11(b), and FIG. 11(c) show TriSoup edges that may be used to entropy code a current TriSoup edge. FIG. 11(a), FIG. 11(b), and FIG. 11(c) show TriSoup edges (E′ and E″) that may be used to entropy code a current edge E. In some instances, five TriSoup edges (E′ and E″) may be used to entropy code a current edge E. The five TriSoup edges may include,
the edge E′ parallel to the current TriSoup edge E and having an end point equal to the start point of the current TriSoup edge E, and
the four edges E″ perpendicular to the current TriSoup edge E and having a start or end point equal to the start point of the current TriSoup edge E.

Depending on the direction of the current TriSoup edge E, either two (FIG. 11(c) for direction z), three (FIG. 11(b) for direction y), or four (FIG. 11(a) for direction x) of the four perpendicular TriSoup edges may have been already coded and their vertex information may be used to construct the neighborhood configuration β_{TS} for the current TriSoup edge E. The TriSoup edge E′ may have already been coded for each direction of the current TriSoup edge E and its vertex information may be used to construct the neighborhood configuration β_{TS} for the current TriSoup edge E independent of its direction.

A neighborhood configuration β_{TS} for a current TriSoup edge E may be obtained from one or more of occupancy bits of cuboids and/or from the vertex information of neighboring already-coded TriSoup edges. For example, a neighborhood configuration β_{TS} for a current TriSoup edge E may be obtained from one or more of the 12 occupancy bits of the 12 cuboids shown in FIG. 10(a) and FIG. 10(b) and from the vertex information of the at most five neighboring already-coded TriSoup edges (E′ and E″) shown in FIG. 11(a), FIG. 11(b), and FIG. 11(c).

Occupancy bits of an octree and bits indicating a presence and/or position of TriSoup vertices may constitute a large part of a bitstream of a compressed representation of a point cloud geometry. These bits may be compressed by using an OBUF scheme, that selects an entropy coder (or probability/context model), followed by entropy coding (e.g., encoding, decoding). Entropy coding may be performed using a coder (e.g., an arithmetic entropy coder) like CABAC. The OBUF scheme may be a bottleneck of the overall codec whose throughput may be related to the computation speed of the OBUF scheme and the entropy coders.

A trade-off between memory footprint and complexity may be considered, for example if the OBUF algorithm is being implemented. Given that the OBUF scheme may be the source of the main codec bottleneck, the speed of the OBUF implementation may be prioritized over the memory footprint of the OBUF implementation. By doing so, the OBUF scheme may have no or little negative impact on slowing down the codec throughput.

As shown by FIG. 5, the selection of an entropy coder (or probability/context model) by the dynamic OBUF process may be obtained by following the branches of its associated tree Tⁿ at some stage ‘n’ of the evolution of dynamic OBUF. For example, as shown with respect to FIG. 5, where the neighborhood configuration ⊕=β₁ . . . β_{K} 500 is equal to β=1001010, an implementation of the OBUF algorithm may follow the tree branches 1, then 0, then 0 until a leaf of the tree Tⁿ is reached. The leaf of the tree Tⁿ may correspond to the dynamically reduced configuration β′=DRⁿ(β)=100. A coder index IDX(β′) may be attached to each leaf of the tree. A quantity (e.g., number) of visits NV(β′) may also be attached to each leaf of the tree. The coder index may indicate a probability model or context for performing CABAC. This implementation of dynamic OBUF may have a low memory footprint because only variables IDX(β′) and NV(β′) are stored for leaves of the tree Tⁿ. However, the tree itself must be stored and grown, for example, if the update phase of dynamic OBUF occurs. This may be obtained with a reasonable memory footprint by some compact tree representations. In certain instances, the computation cost for reaching the leaves of the tree Tⁿ may pose a problem. For example, a neighborhood configuration may have up to 20 bits of information (i.e., K=20) and obtaining the coder (or probability/context model) index IDX(β′) may cost up to 20 unpredictable branching operations, which may slow down the dynamic OBUF process and lead to a throughput that may not satisfy typical codec requirements.

Other implementations of dynamic OBUF may be used based on a different trade-off: e.g., increasing speed but at the price of a larger memory footprint. Increased speed may only be achieved if the memory itself is fast enough to access data, e.g., IDX(β′), that are accessed randomly in the memory. For CPU-based implementations of dynamic OBUF, this may imply that the OBUF memory footprint may not exceed the size of the cache memory of the processor. For hardware implementations, fast random-access memory may be expensive and may not be expanded beyond certain limits for cost and implementation reasons. The upper limit for random-access memory may be in the range of a few megabits (MBs) for both implementations.

A fast implementation of dynamic OBUF may rely on three big arrays k[], IDX[] and NV[] of size 2^{K}, where K is the quantity (e.g., number) of bits of the neighborhood configuration β used as input to the OBUF process. There may be as many entries to these three arrays as there are possible values of the neighborhood configuration β.

A first array k[] may be used to obtain the reduced configuration β′=β₁ 1 . . . β_{kn(β)} from the configuration β=β₁ . . . β_{K}. The value k[β] may indicate the quantity (e.g., number) of bits that are dropped and then replaced (e.g., canonically replaced) by zeros, such that k[β] is defined by being equal to K−β_{kn(β)}. The reduced configuration β′ may be obtained by simple bit shifting operations

$$β ’ = ( β >> k [ β ] ) << k [ β ]$$

where β′ may have been padded to the right by k[β] zeros, for example, to have K bits like β. Bits (or symbols) that are dropped and then replaced (e.g., canonically replaced) by zeroes may be referred to as masked bits (or masked symbols). The value k[β] may indicate the quantity (e.g., number) of bits, or quantity (e.g., number) of symbols, from the configuration β that are masked.

A second array IDX[] may contain the coder indices and the selection of an entropy coder (or probability/context model), which may be obtained through the index

$$idx = IDX [ β ’ ] .$$

The value IDX[β′] may be updated, for example, based on a coded bit associated with the index idx. The value IDX[β′] may be updated based on a coded bit, for example, after coding the bit by the coder pointed by the index idx.

A third array NV[] may contain the quantity (e.g., number) of visits of the reduced configurations. The quantity (e.g., number) of visits may be incremented for the visited reduced configuration β′. The quantity (e.g., number) of visits may be incremented for the visited reduced configuration β′, for example, after coding of a bit.

$$N V [ β ’ ] ++$$

Dynamic OBUF may be updated such as to split the reduced configuration β′ into two new reduced configurations α′0 and β′1, as explained herein. Dynamic OBUF may be updated such as to split the reduced configuration β′ into two new reduced configurations β′0 and β′1, for example, if NV[β′] becomes higher than some threshold and k[β] is not equal to zero. The values of the two new reduced configurations may be

$$β ’ 0 = β ’ and β ’ 1 = β ’ + ( 1 << k [ β ] - 1 ) .$$

The coder index may be copied into the second new configuration

$$I D X [ β ’ 1 ] = I D X [ β ’ ]$$

and the quantity (e.g., number) of visits may be reinitialized to zero.

$$N V [ β ’ 0 ] = N V [ β ’ 1 ] = 0$$

The quantity (e.g., number) of unused bits may be decremented for all configurations β′+j, which leads to a reduced configuration β′.

$$k [ β ’ + j ] = k [ β ’ ] - 1 for all j in [ 0 ; {2}^{k [ β ]} ]$$

Except for the update of k[], all operations may be straightforward and fast. The update of k[] may not be performed each time a bit is coded, and may require 2^{k[β]} operations that is bounded by 2^{K}, which may be a large value.

The concept of primary and secondary contextual information, namely CI₁ and CI₂, may be introduced. The primary contextual information CI₁ may be used entirely, for example, if the secondary contextual information CI₂ may be input to a dynamic OBUF scheme such that the coder index idx is found based on CI₁ and the reduction of CI₂. Assuming CI₁ has K₁ bits and CI₂ has K₂ bits, there may be virtually 2^{K1} OBUF trees Tⁿ_{CI1}, index by CI₁, that take CI₂ as entry. This may be considered equivalent to splitting the configuration β into two parts β=(CI₁, CI₂), for a total bit-length K=K₁+K₂. Additionally, this may be considered equivalent to using a single OBUF scheme to the whole β. For example, the single OBUF scheme may start with an array k[] initialized to K₂, and not initialized to K. This may result in the first K₁ bits never being masked.

Initializing the array k[] to K₂ may have a positive effect on the complexity of updating this array because it may lead to a bound on the quantity (e.g., number) of operations equal to 2^{K2}, instead of a bound on the quantity (e.g., number) of operations being equal 2^{K}. K₂ may be lower than a value (e.g., ten) and the update operations may be quick enough to be performed between two calls of a same dynamic OBUF instance. This may assist in the dynamic OBUF having computationally low complexity and being fast (update included).

Big arrays k[], IDX[] and NV[] may have size 2^{K} where K may be as high as 20. A typical value for K, for example, may be 18. This may lead to 3*2¹⁸ (e.g., around one million) array elements per instance of dynamic OBUF. There may be several instances of dynamic OBUF, for example, one for each of the eight occupancy bits of the eight child nodes of a parent node in the octree structure. This may lead to tens of millions of array elements. The memory footprint associated with these instances of dynamic OBUF may become too big to allow the local coding process to stay in a cache memory, which may lead to the coding speed performance being negatively impacted by non-cache memory traffic. A reduction of dynamic OBUF memory footprint may be obtained by simplifying a deeper part of the OBUF trees Tⁿ (e.g., far from the root node of the OBUF trees). The quantity (e.g., number) of array elements may be reduced to reach a memory footprint allowing for the OBUF scheme to be entirely processed within fast memory (e.g., cache memory).

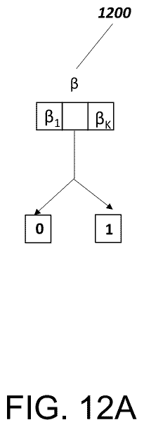

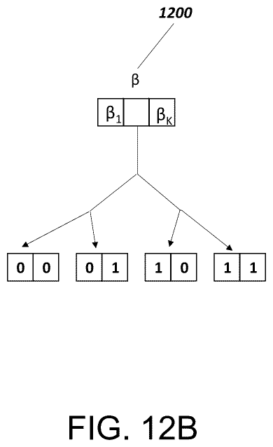

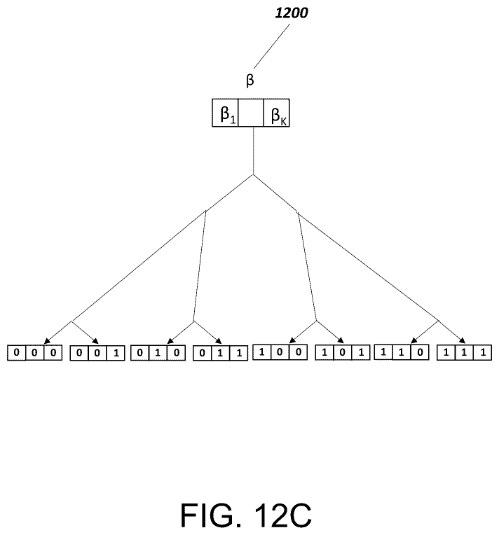

FIG. 12A, FIG. 12B and FIG. 12C show examples of a simplified OBUF tree. The dynamic OBUF process may take an input configuration β (e.g., input configuration β1200) made of three bits β=β₁β₂β₃ such that the OBUF tree Tⁿ may grow to a maximum depth d=K=3. Instead of using three arrays k[], IDX[] and NV[] of size 2^{K}=2³=8, two scalar value k and NV may be used instead, and only one single array IDX[] may be needed. The value k may be common to all configurations β and may indicate the quantity (e.g., number) of bits that are dropped for any configuration β to obtain a reduced configuration β′. The coder index may be obtained by

$$β ’ = ( β >> k ) << k ,$$

$$idx = IDX [ β ’ ] ,$$

where the array IDX[] may have a same role as in the non-simplified tree structure as described herein. The value NV may also be common to all reduced configurations β′ and may indicate the aggregated total quantity (e.g., number) of visits for all leaf nodes of the tree Tⁿ. The value NV may be incremented (NV++). The value NV may be incremented (NV++), for example, after each coding of a bit by dynamic OBUF. Dynamic OBUF may be updated by splitting all leaf nodes, reinitializing the quantity (e.g., number) of visits to zero (NV=0) and decreasing the quantity (e.g., number) of dropped bits by one (k−−) for example, if the value NV is higher than some threshold and k is not equal to zero. All leaf nodes may have the same depth and their quantity (e.g., number) may be doubled, for example, after each update. The quantity (e.g., number) of leaf nodes may be doubled after each update, for example, as shown by FIG. 12A, FIG. 12B and FIG. 12C showing the successive updates for the example of K=3. The update of IDX[] may be the same as for the non-simplified tree: both new leaf nodes (associated with β′0 and β′1) may inherit from the index value of their parent (old leaf node associated with β′)

$$I D X [ β ’ 1 ] = I D X [ β ’ ] .$$

This inheritance may be performed for all old leaf nodes (associated with β′) that are all split, for example, if the update occurs.

A simplified tree approach may have a memory footprint of size 2^{K} due to the use of a single array IDX[] instead of 3*2^{K} for a non-simplified tree that involves the three arrays k[], IDX[] and NV[]. The memory footprint may be reduced by a factor of three.

Using a fully simplified tree from the root node of the OBUF tree Tⁿ may lead to a loss of compression performance because visit statistics may not be well tracked. A hybrid approach may be used by combining a non-simplified tree and a simplified tree. A non-simplified tree (e.g., a “leaf-per-leaf” grown tree) may be used for depths lower than a threshold depth dₗₚₗ and a simplified tree may be used for depths higher than dₗₚₗ.

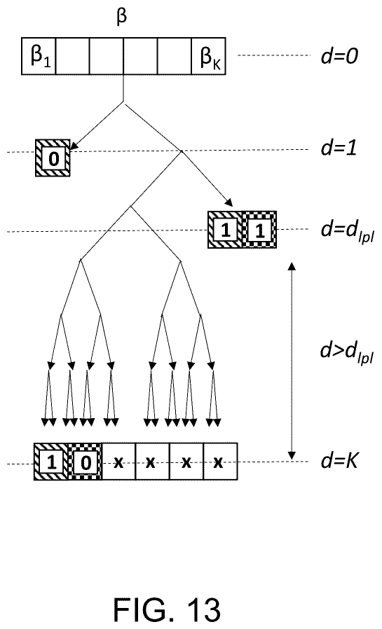

FIG. 13 shows an example of a hybrid OBUF tree. More specifically, FIG. 13 shows an example hybrid non-simplified and simplified OBUF tree. As shown in FIG. 13, for example, a leaf-per-leaf tree may be used for depths d between 0 (e.g., the root node) and dₗₚₗ, and simplified trees may be attached to nodes at depth d=dₗₚₗ. The simplified trees may cover depths from dₗₚₗ to K. The simplified trees may have a maximum depth of

$${d}_{s i m p} = K - {d}_{lp l} .$$

The size of the two arrays k[] and NV[] may thus be reduced to 2^{dlpl} instead of 2^{K}. An intermediate leaf-per-leaf configuration βₗₚₗ may be obtained by dropping dₛᵢₘₚ bits from the entry configuration β

$${β}_{lpl} = β >> {d}_{s i m p} .$$

Then, the reduced configuration β′ may be obtained by

$$β ’ = ( β >> k [ {β}_{lpl} ] ) << k [ {β}_{lpl} ]$$

and the coder index may be obtained by

$$idx = IDX [ β ’ ] .$$

The update process may depend on the value of k[βₗₚₗ]. The child nodes of the involved node associated with β′ may still be in the leaf-per-leaf part of the tree, for example if k[βₗₚₗ]22 dₗₚₗ. The update may be performed as in a leaf-per-leaf tree of maximum depth dₗₚₗ. The child nodes of the involved node associated with β′ may not belong to the leaf-per-leaf, for example, if k[βₗₚₗ]≤dₗₚₗ. The child nodes may belong to the simplified tree attached to the node associated with βₗₚₗ, and the update may be performed as in a simplified tree of maximum depth dₛᵢₘₚ. The update may be performed as in a simplified tree of maximum depth dₛᵢₘₚ, for example, by updating the quantity (e.g., number) of dropped bits k[βₗₚₗ] and the quantity (e.g., number) of visits NV[βₗₚₗ] that play the role of scalar k and NV for the simplified tree attached to the node of the leaf-per-leaf tree associated with βₗₚₗ. The memory footprint may be reduced close to the minimum limit of 2^{K} (instead of 3*2^{K} for a full leaf-per-leaf tree) without impacting the compression performance much, for example, by choosing a not too large simplified tree depth dₛᵢₘₚ (e.g., 3 or 4),

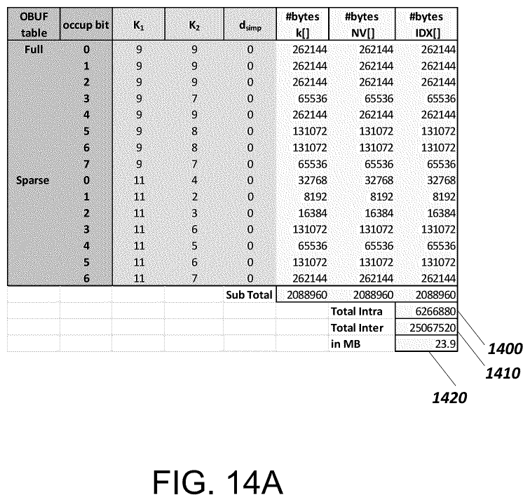

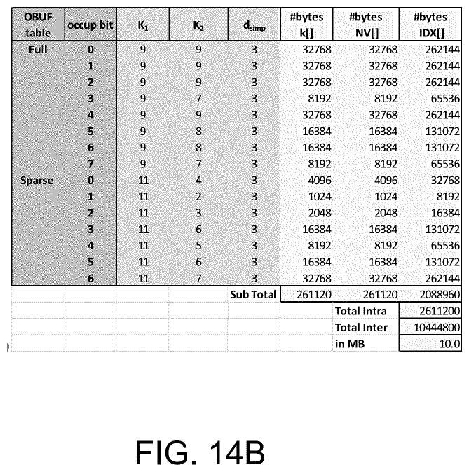

FIG. 14A and FIG. 14B show examples of OBUF memory footprints. More specifically, two examples of memory footprints involving leaf-per-leaf and simplified OBUF trees are described with respect to the two tables shown in FIG. 14A and FIG. 14B. The tables show the footprint of OBUF used for coding the eight occupancy bits of the eight child nodes of a parent node belonging to an octree representing the geometry of the point cloud.

As shown in FIG. 14A and FIG. 14B, there may be 15 instances of OBUF for two base cases, namely “Full” and “Sparse”, that are selected depending on the presence (or absence) of close occupied neighbors of a current octree node. For the “Sparse” case, the eighth occupancy bit may be inferred to be “occupied” because the seven sibling occupancy bits are known to be unoccupied, and no OBUF instance may be needed for the eighth “Sparse” bit. The sizes K₁ and K₂ of the first and secondary contextual information CI₁ and CI₂. constituting the configuration β, may depend on each OBUF instance. The depth dₛᵢₘₚ of the simplified tree attached to the leaf-to-leaf tree depends on the example. For instance, referring to a first example shown in FIG. 14A, no simplified tree is used, thus dₛᵢₘₚ=0 in this example. In a second example, shown in FIG. 14B, a simplified tree having a depth equal to 3 is used, thus dₛᵢₘₚ=3 in this second example.

The quantity (e.g., number) of elements may be 2^{K}=2^{K1}*2^{K2} for the array IDX[], and may be 2^{dlpl}=2^{K-dsimp} for the two arrays k[] and NV[]. Each array element may be an 8-bit unsigned integer such that the memory footprint is one byte per element. The tables in FIG. 14A and FIG. 14B show the footprints of each array for each OBUF instance, and these footprints may be summed up to obtain a total footprint, e.g., “Total Intra” 1400 as shown in FIG. 14A. This total may correspond for intra coding of the octree. For inter coding, there may be four modes of coding, namely “intra”, “inter predicted non-occupied”, “inter predicted weakly occupied” and “inter predicted strongly occupied”. The footprint may then be multiplied by four and may correspond to the “Total inter” 1410, which is converted into mega-bytes (MB), as shown by element 1420 in FIG. 14A.

The footprint may be 23.9 MB, for example, if no simplified tree is used (e.g., dₛᵢₘₚ=0 as shown in FIG. 14A), The footprint may be 10.0 MB, first example, if simplified trees are used (e.g., dₛᵢₘₚ=3 as shown in FIG. 14B). The compression loss due to simplified trees of depth 3 may be 0.4% but may grow quickly, for example, if the depth dₛᵢₘₚ is increased.

By using simplified OBUF trees, the memory footprint of the two arrays k[] and NV[] may be decreased down to almost zero. The size of the array IDX[] may remain unchanged at the size equal to the quantity (e.g., number) 2^{K} of possible configurations β. Therefore, the use of simplified OBUF trees may allow for a reduction of the memory footprint by a factor of three without changing the asymptotic behavior of the footprint relative to the quantity (e.g., number) of configurations. This use of simplified OBUF trees may lead to footprints that are in the order of 10 MB, which may be big for cache memory.

Further decreasing the memory footprint as a function of the quantity (e.g., number) of possible configurations β may not only allow for an easier implementation of the codec but may also provide a better trade-off between compression (driven by the quantity (e.g., number) of possible configurations β) vs. case of implementation (driven by the memory footprint). By reversing this approach for a given memory footprint, more configurations may be used, which may lead to better compression.

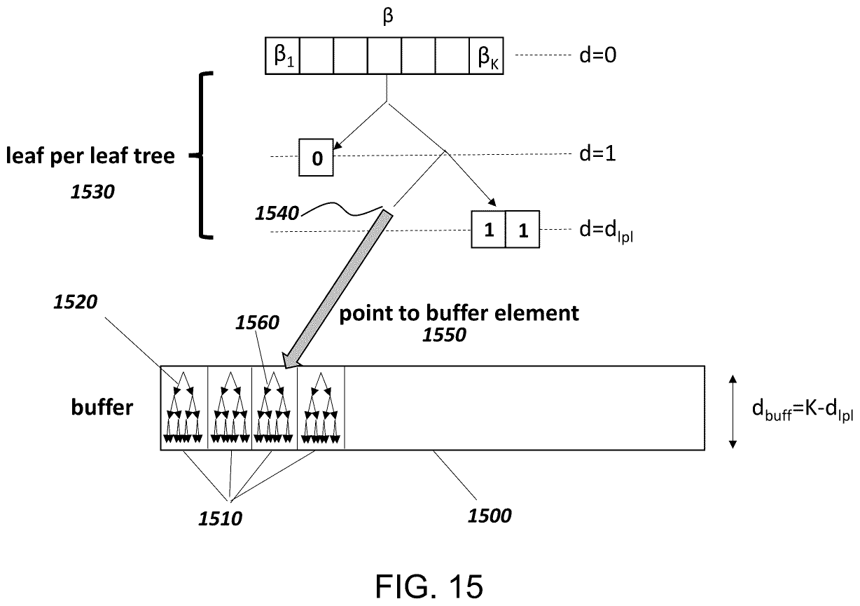

To achieve such improvements, it may be important to obtain an asymptotic behavior of the memory footprint better than O(2^{K}). FIG. 15 shows an example OBUF tree and buffer. As shown in FIG. 15, a simplified OBUF tree, used from depth dₗₚₗ, may be replaced by a buffer (or buffer array) 1500 made of buffer elements 1510 that may each represent a buffer tree 1520 having total depth equal to

$${d}_{buff} = K - {d}_{lp l} .$$

A leaf node (e.g., leaf node 1540), at depth dₗₚₗ, of the leaf-per-leaf tree 1530 may indicate or point to (e.g., point 1550) a buffer element, which may become a continuation of the node of the leaf-per-leaf tree down to a maximum depth K. The buffer element may become a continuation of the node of the leaf-per-leaf tree down to a maximum depth K, for example, by “plugging” the buffer tree 1560, associated with the pointed buffer element, to the leaf node 1540.

FIG. 16 shows an example common buffer shared by OBUF trees. As shown in FIG. 16, the buffer may be a common buffer (e.g., common buffer 1600) shared by several leaf-per-leaf OBUF trees (e.g., OBUF trees 1610, 1611 and 1612). The leaf-per-leaf OBUF trees 1610, 1611 and 1612 may not have the same depth dₚₗₚ but may have in common a same depth d_{buff} of tree continuation by buffer elements. Leaf nodes of the several leaf-per-leaf OBUF trees may indicate (e.g., point to) buffer elements of the common buffer 1600.

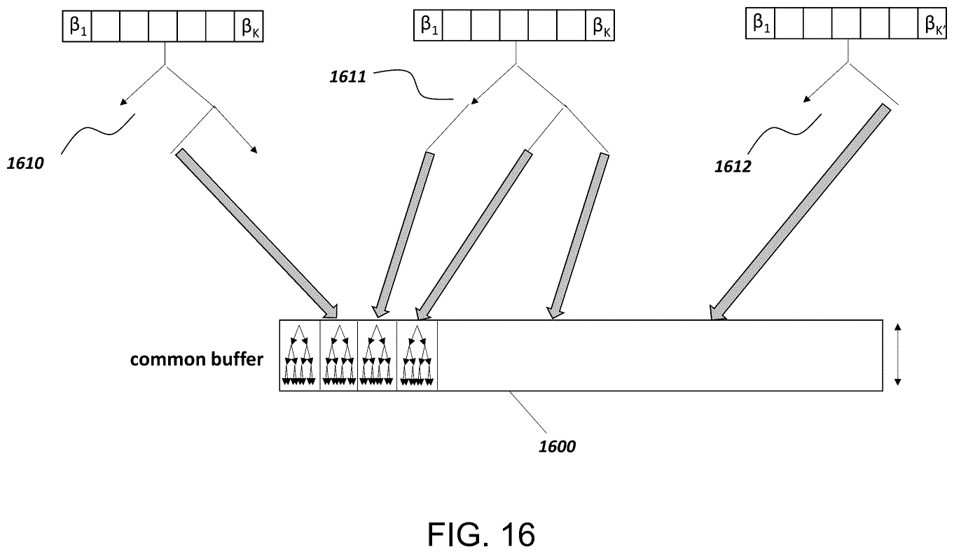

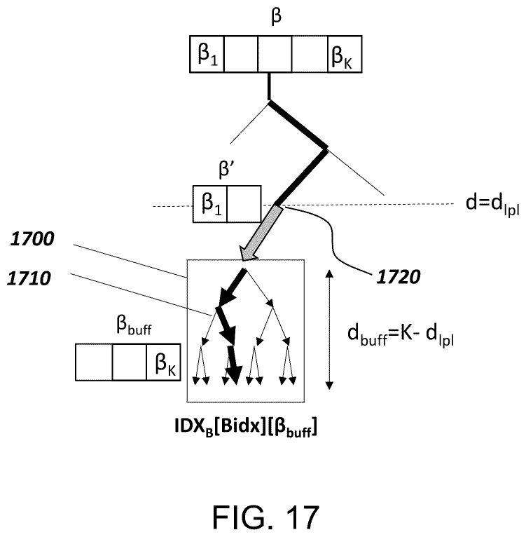

FIG. 17 shows an example of a leaf-per-leaf tree. More specifically, a process of continuation of the leaf-per-leaf tree by buffer elements is described herein with respect to FIG. 17, where an example is shown for K=5, dₗₚₗ=2 and d_{buff}=3. A configuration β may be reduced into a reduced configuration β′ following the leaf-per-leaf tree as discussed herein. This tree may be considered as a tree of maximum depth dₗₚₗ taking

$${β}_{lpl} = β ≫ {d}_{buff}$$

as an entry configuration. The entry βₗₚₗ has dₗₚₗ bits. Three arrays kₗₚₗ[], IDXₗₚₗ[] and NVₗₚₗ[] of size 2^{dlpl} may represent the leaf-per-leaf tree. A reduced configuration β′ may be obtained by

$${β}^{′} = ( {β}_{lpl} ≫ {k}_{lpl} [ {β}_{lpl} ] ) ≪ {k}_{lpl} [ {β}_{lpl} ] .$$

A process of determining a coder index idx may depend on the value of kₗₚₗ[βₗₚₗ]. The node associated with β′ may not be a maximum-depth leaf node of the leaf-per-leaf tree, for example, if kₗₚₗ[βₗₚₗ]>0. The node associated with β′ may not be a maximum-depth leaf node of the leaf-per-leaf tree, and the index may be represented by idx=IDXₗₚₗ[β′]. The update of the leaf-per-leaf tree (i.e., update of the arrays kₗₚₗ[], IDXₗₚₗ[] and NVₗₚₗ[]) may be performed as discussed herein (e.g., as discussed herein with respect to FIG. 13).

A buffer element index may be obtained. A buffer element index may be obtained, for example, if kₗₚₗ[βₗₚₗ]=0, as

$$Bidx = buffElemIdx [ {β}^{′} ]$$

The buffer element 1700 may be pointed to by the buffer element index Bidx. The buffer element 1700 may contain (or represent) a tree (e.g., tree 1710) extending the leaf-per-leaf tree from its leaf node 1720. The leaf node (e.g., leaf node 1720) may be associated with the reduced configuration β′=βₗₚₗ. The buffer tree 1710 may have depth d_{buff}.

A buffer configuration β_{buff} may be obtained as the last d_{buff} bits of the entry configuration β. The buffer configuration β_{buff} may be obtained, for example, by a masking operation.

$${β}_{buff} = β \& ( ( 1 ≪ {d}_{buff} ) - 1 )$$

The representation of the tree 1710 associated with the buffer element 1700 may be a single array IDX_{B}[Bidx][] of size 2^{dbuff}. The coder index may be obtained from this array, for example, by

$$idx = {IDX}_{B} [ Bidx ] [ {β}_{buff} ] .$$

The tree 1710 associated with the buffer element 1700 may be an already fully grown tree down to its maximum depth d_{buff}. This may be advantageous because the memory footprint of buffer elements may be reduced by not using arrays for k and NV. This may also be advantageous because the processing of buffer elements may be reduced to a simple memory access to the single array IDX_{B}. The buffer may be implemented as a single contiguous array of coder indices having a single entry IDX_{B}[] such that the coder index idx may be obtained using simple operations and memory access by

$$idx = {IDX}_{B} [ ( Bidx ≪ {d}_{buff} ) + {β}_{buff} ] .$$

A memory footprint may be given by adding (e.g., compounding) the memory footprint of the leaf-per-leaf trees (e.g., one per OBUF instance) and the memory footprint of the buffer. For N_{OBUF} instances of OBUF and N_{buffer} buffer elements, the total memory footprint may be

$$3 * {N}_{OBUF} * {2}^{dlpl} + {N}_{buffer} * {2}^{dbuff} .$$

Buffer element index buffElemIdx[β′] may need to be stored. The buffer element index buffElemIdx[β′] may be stored in a forth array buffElemIdx[] of size 2^{dlpl}. Storing the buffer element index buffElemIdx[β′] a forth array buffElemIdx[] of size 2^{dlpl} may change the first factor (e.g., 3) in the memory footprint formula above into a different factor (e.g., a factor of 4). This changing of factors may be avoided by “hiding” the value of buffElemIdx[β′] into already existing arrays.

Buffer element index buffElemIdx[β′] may be defined, for example, if kₗₚₗ[βₗₚₗ]=0. The two values NVₗₚₗ[βₗₚₗ] and IDXₗₚₗ[βₗₚₗ] may not be used by the leaf-per-leaf tree representation, for example, if the buffer element index buffElemIdx[β′] is defined as Kₗₚₗ[βₗₚₗ]=0. The buffer element index buffElemIdx[β′] may be hidden into the two values NVₗₚₗ[βₗₚₗ] and IDXₗₚₗ[βₗₚₗ]. The buffer element index may be hidden as follows

$$Bidx = ( {IDX}_{lpl} [ {β}_{lpl} ] ≪ 8 ) + {NV}_{lpl} [ {β}_{lpl} ] ,$$

for example, if 8-bit unsigned integers are used for array elements. By doing so, up to 16-bit buffer element indices may be hidden. This may be a sufficient size.

In some implementations of a point cloud codec, such as software-based or hardware-based implementations, a maximum memory available size may be used to design the underlying hardware. This size may be designed to meet a worst-case scenario of memory footprint of the codec. Unfortunately, the proposed buffer may grow to a somewhat undefined quantity (e.g., number) of buffer elements. An a priori upper bound may be determined from the quantity (e.g., number) of points of the point clouds and the threshold on the quantity (e.g., number) of visits NV, but this manner of determining the upper bound may be a gross approximation, which may largely overestimate a practical bound.

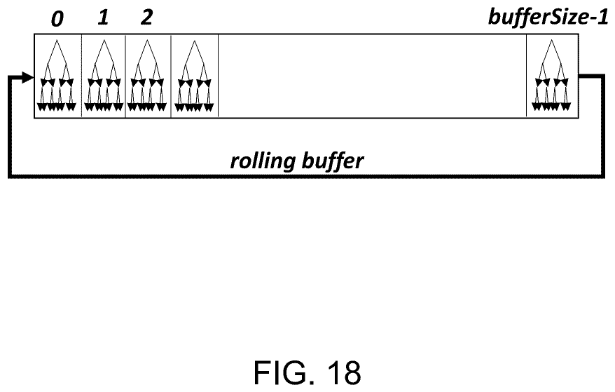

FIG. 18 shows an example buffer. A syntax element bufferSize may be used to signal and fix the maximum quantity (e.g., number) of elements of the buffer. Consequently, buffer element indices Bidx may belong to the range [0, bufferSize] as shown by FIG. 18. The buffer memory footprint may this correspond to

$$buffer footprint = bufferSize * {2}^{dbuff} .$$

Determining a buffer element index Bidx for a leaf node of a leaf-per-leaf tree of an OBUF instance may be performed as described herein. A global variable lastBidx may represent the index of the buffer element just after the last attached buffer element to a leaf node of any of the leaf-per-leaf trees is updated. The global variable lastBidx may be updated, for example, after each attachment by being incremented by one. The variable may be initialized to zero at the start of the coding, and thus may refer to the first buffer element. A buffer element index Bidx may be taken as equal to lastBidx, for example, if performing an attachment of a buffer element to a leaf node of a leaf-per-leaf tree, and lastBidx may be incremented by one. By incrementing the variable lastBidx by one, the buffer may be used entirely, from “left to right”. All buffer elements in the range [0; lastBidx] may be attached to a leaf node of a leaf-per-leaf trees of an OBUF instance, but the buffer elements having an index equal to or greater than lastBidx may not be attached yet.

By setting a buffer size bufferSize, the index lastBidx may be incremented beyond bufferSize −1, which may result in the indication (e.g., pointing to) of an invalid buffer element. This issue may be resolved by implementing the buffer as a rolling buffer and looping from the end of the buffer to the start of the buffer., The index lastBidx may be looped back by being reset to zero or some other value within the range [0, bufferSize], for example, if the index lastBidx is incremented to be equal to bufferSize.

A buffer element may be attached to more than one leaf node of leaf-per-leaf trees of OBUF instances, for example, if a rolling buffer is used. This may harm the compression performance if these two trees have incompatible statistics. For instance, bits equal to 1 may be mostly coded, for example, if the buffer configuration β_{buff} comes from a first OBUF instance. Bits equal to 0 may be mostly coded, for example, if the buffer configuration β_{buff} comes from a second OBUF instance. The buffer element may see alternative coding of 0 and 1 without good common statistics, and the coder indices IDX_{B}[][] may poorly model the signal by “averaging” these common statistics to a probability close to 0.5 to code a 0 or a 1.

An already-used buffer element may be attached to a (at least second) leaf node to which it is statistically compatible, for example, after rolling the buffer. Blind incrementation of the index lastBidx may not be able to achieve this goal. The evolution of the index lastBidx may be changed, for example, after rolling the buffer.

A statistically compatible buffer element may be searched for within some search range of buffer indices. The range of buffer indices may correspond to a range [lastBidx; lastBidx+N_{search}], where N_{search} may define the size of the search range. N_{search} may correspond to variety of different values. An example value for N_{search} may be 10 or 20. The coder index of the leaf node to which a buffer element is to be attached may be IDXₗₚₗ[β]=IDXₗₚₗ[βₗₚₗ], where β′ may be obtained from some configuration β, for an array IDXₗₚₗ representing the leaf-per-leaf tree to which the leaf node belongs to. A buffer configuration β_{buff} may also be obtained from the configuration β. A compatible buffer element (or a most compatible buffer element) may be defined as an element that minimizes the coder index distance |IDXₗₚₗ[β′]−IDX_{B} [b][β_{buff}]|, where b may be a buffer index belonging to the search range. The buffer index Bidxₒₚₜ of the compatible leaf node may then be given by the equation

$${Bidx}_{opt} = arg {min}_{b ∈ [ lastBidx , lastBidx + {N}_{s earch} [} \vert {IDX}_{lpl} [ {β}^{′} ] - {IDX}_{B} [ b ] [ {β}_{buff} ] \vert$$

The global variable lastBidx may be updated to Bidxₒₚₜ+1 to start a next search range from the buffer element. The next search range may start just after the determined most compatible buffer element. The variable lastBidx may again loop back to the start of the buffer, for example, if the end of the buffer is reached.

A buffer element may be initialized, for example, if the buffer element is attached to a leaf node of a leaf-per-leaf tree. This may be performed by setting all values of the array IDX_{B}[Bidx][], having size 2^{dbuff}, to a common value IDXₗₚₗ[β′]=IDXₗₚₗ[βₗₚₗ] equal to the coder index associated with the leaf node.

The evolution of the array IDX_{B}[Bidx][] may be performed, for example, after each coding of a bit coded by a coder (e.g., entropy coder) selected by the tree of buffer element. The selected coder may have been indicated (e.g. pointed to) by a coder index IDX_{B}[Bidx][β_{buff}] for some buffer configuration β_{buff}. IDX_{B}[Bidx][β_{buff}] may evolve, for example, if the bit is coded.

The third array NVₗₚₗ[] may contain the quantity (e.g., number) of visits of the reduced configurations. The quantity (e.g., number) of visits may be incremented for the visited reduced configuration β′, for example, if a bit is coded. The quantity (e.g., number) of visits may be incremented for the visited reduced configuration β′

$${NV}_{lpl} [ {β}^{′} ] ++$$

Dynamic OBUF may be updated such as to split the reduced configuration β′ into two new reduced configurations β′0 and β′1, as explained herein. Dynamic OBUF may be updated such as to split the reduced configuration β′ into two new reduced configurations β′0 and β′1, for example, if NVₗₚₗ[β′] becomes higher than some threshold and kₗₚₗ[βₗₚₗ] is not equal to zero. The values of the two new reduced configurations may be

$${β}^{′} 0 = {β}^{′} and {β}^{′} 1 = {β}^{′} + ( 1 ≪ {k}_{lpl} [ {β}_{lpl} ] - 1 ) .$$

The coder index may be copied into the second new configuration

$$I D {X}_{lpl} [ {β}^{′} 1 ] = I D {X}_{lpl} [ {β}^{′} ]$$

and the quantity (e.g., number) of visits may be reinitialized to zero.

$$N {V}_{lpl} [ {β}^{′} 0 ] = N {V}_{lpl} [ {β}^{′} 1 ] = 0$$

The quantity (e.g., number) of unused bits may be decremented for all configurations β′+j that leads to a reduced configuration β′

$$k [ {β}^{′} + j ] = k [ {β}^{′} ] - 1 for all j in [ 0 ; {2}^{k [ β ]} ] .$$

A buffer element may be attached to the leaf node by setting buffElemIdx[β′] equal to a buffer element index using one of the approaches discussed herein. A buffer element may be attached to the leaf node by setting buffElemIdx[β′] equal to a buffer element index, for example, if NVₗₚₗ[β′] becomes higher than some threshold and kₗₚₗ[βₗₚₗ] is equal to zero.

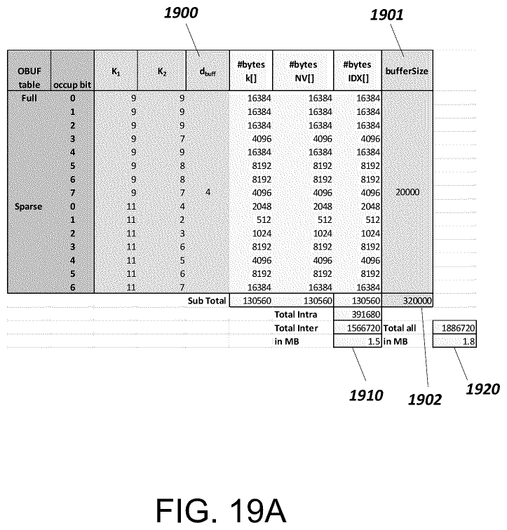

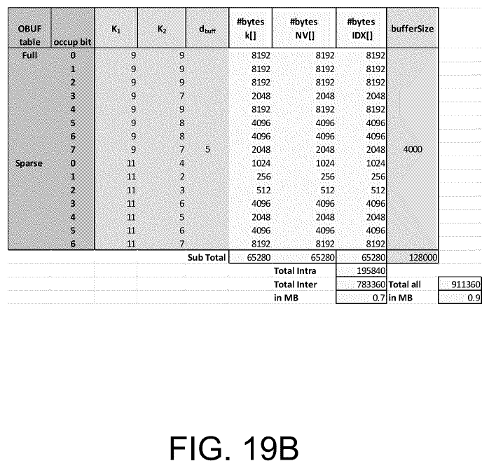

FIG. 19A and FIG. 19B show examples of OBUF memory footprint. More specifically, FIG. 19A and FIG. 19B show two tables representing two examples of OBUF memory footprint in accordance with the simplified OBUF trees described herein. The two tables shown in FIG. 19A and FIG. 19B are similar to the tables shown in and described with respect to FIG. 14A and FIG. 14B, except for the simplified tree depth dₛᵢₘₚ being replaced by a buffer depth d_{buff} 1900 common to all OBUF instances, and except for one buffer 1901 of size bufferSize elements having been added. The memory footprint 1902 of the buffer may be given by bufferSize*2^{dbuff}. The total footprint 1910 of the leaf-per-leaf trees may be the compound of the footprints of the three arrays kₗₚₗ[], IDXₗₚₗ[] and NVₗₚₗ[], which each have a size 2^{dlpl}=2^{K-dbuff}. The total memory footprint 1920 may be the sum of the footprint 1902 of the buffer and the footprint 1910 of the leaf-per-leaf trees.

The table shown in FIG. 19A shows an example with a buffer depth d_{buff}=4 and a big buffer (having 20000 elements) that may rarely roll back to its first element due to the size of the buffer. In comparison to the table shown in FIG. 14B, the OBUF memory footprint of the example shown in FIG. 19A has been reduced from 10 MB to 1.8 MB. The observed compression performance shows an increase of the bitrate by only 0.1%.

The table shown in FIG. 19B shows an example with a buffer depth d_{buff}=5 and a smaller buffer (having 4000 elements) that may roll back more frequently to its first element due to its smaller size. In comparison to the table shown in FIG. 14B, the OBUF memory footprint of the example shown in FIG. 19B has been reduced from 10 MB to 0.9 MB. The observed compression performance shows an increase of the bitrate by 0.7%.

A point cloud encoder and decoder may both construct and process the buffer using the same method in order to maintain their synchronization in selecting the entropy coders (or equivalently their associated probabilities or context models). Therefore, the encoder and decoder may have the same buffer size and implement the same rolling method, as described herein. For example, both the encoder and the decoder may use the same values for bufferSize, d_{buff} and/or N_{search}. The syntax elements bufferSize, d_{buff} and/or N_{search} may be coded (e.g., encoded) into the bitstream by the encoder. The syntax elements bufferSize, d_{buff} and/or N_{search} may be coded (e.g., decoded) from the bitstream by the decoder, for example, to ensure synchronization.

The syntax elements bufferSize, d_{buff} and/or N_{search} may be set through codec “profiles” or “levels”. The codec “profiles” or “levels” may be defined by the specification of the codec. The decoder may obtain the codec profile/level information by some means, for example, from the encoded bitstream. The decoder may obtain the codec profile/level information to ensure the use of the same profile/level as the encoder. Each codec profile/level may define values for the syntax elements bufferSize, β_{buff} and/or N_{search}.

FIG. 20A shows an example method for coding vertex information of a current edge. More specifically, FIG. 20A shows a flowchart 2000 of example method steps for encoding vertex information of a current edge. One or more steps of the example flowchart 2000 may be performed by an encoder 114 as described herein with respect to FIG. 1.

At step 2002, an encoder may determine a neighborhood configuration of a first edge (or a first TriSoup edge) of a TriSoup node of a point cloud. The neighborhood configuration may be determined, for example, based on already-coded presence flags and positions (of present TriSoup vertices) of TriSoup edges. The neighborhood configuration may correspond to configuration β described herein with respect to FIG. 15, FIG. 16, FIG. 17 and FIG. 18.

At step 2004, an encoder may index a first buffer element index array. The encoder may index a first buffer element index array based on a quantity (e.g., number) of symbols of a first part of the neighborhood configuration that are masked. The encoder may index a first buffer element index array based on the first part of the neighborhood configuration to determine a first index for a range of coder indices in a buffer array. With respect to the description of FIG. 15, FIG. 16, FIG. 17 and FIG. 18 herein, the first part of the neighborhood configuration may correspond to βₗₚₗ, the quantity (e.g., number) of symbols of the first part of the neighborhood configuration that are masked may correspond to kₗₚₗ[βₗₚₗ], the first buffer element index array may correspond to buffElemIdx[] (or the concatenation of values in arrays NVₗₚₗ[] and IDXₗₚₗ[]), the first index may correspond to Bidx, and the buffer array may correspond to either the one-dimensional version of array IDX_{B}[] or the two-dimensional version of array IDX_{B}[][].

A first buffer element index array may be indexed, for example, based on the quantity (e.g., number) of symbols of the first part of the neighborhood configuration that are masked being equal to zero. A buffer array may be a one-dimensional array and the index for the range of coder indices may indicate a starting location of the range of coder indices in the buffer array. The buffer array may be a two-dimensional array and indexing the buffer array, to determine the coder index, ,ay comprise indexing: a first dimension of the buffer array using the first index for the range of coder indices; and a second dimension of the buffer array using the second part of the neighborhood configuration. The memory associated with the range of coder indices may be a buffer element (e.g., buffer element 1550 as described herein with respect to FIG. 15) of the buffer array.

A first index for the range of coder indices in the buffer array may be determined based on a global variable that is incremented. The global variable may be incremented, for example, after a buffer element of the buffer array is attached to a leaf node of an OBUF instance. The global variable may be re-initialized to a starting value, for example, if the global variable is incremented a quantity (e.g., number) of times. The quantity (e.g., number) of times that the global variable is incremented may be equal to a quantity (e.g., number) of buffer elements in the buffer array. The starting value may be zero. The global variable may correspond to lastBidx as described herein with respect to FIG. 15, FIG. 16, FIG. 17 and FIG. 18.

A first index for the range of coder indices in the buffer array may be determined. A first index for the range of coder indices in the buffer array may be determined, for example, after the global variable is re-initialized to a starting value. A first index for the range of coder indices in the buffer array may be determined, for example, based on a distance of a first coder index to a second coder index. The first coder index may be associated with the first part of the neighborhood configuration. The second coder index may be stored in a buffer element of the buffer array at an index associated with the second part of the neighborhood configuration. The second coder index may be determined to have a smallest distance to the first coder index among coder indices of a plurality of buffer elements, of the buffer array, associated with the second part of the neighborhood configuration. The quantity (e.g., number) of the plurality of buffer elements may be determined, for example, based on a search range size. The search range size may be sent (e.g., transmitted) by the encoder over a bitstream and/or received by the decoder from the bitstream.

At step 2006, an encoder may index the buffer array. The encoder may index the buffer array to determine a coder index. The encoder may index the buffer array to determine a coder index based on: the first index for the range of coder indices; and a second part of the neighborhood configuration. With respect to FIGS. 15-18 described herein, the second part of the neighborhood configuration may correspond to β_{buff} and the code index may correspond to either idx=IDX_{B}[(Bidx<<d_{buff})+β_{buff}] or idx=IDX_{B}[Bidx][β_{buff}].

At step 2008, an encoder may select a context or probability model for coding vertex information of the first edge. The encoder may select a context or probability model for coding vertex information of the first edge, for example, based on the coder index.

At step 2010, an encoder may code (e.g., entropy encode) the vertex information of the first edge. The encoder may code (e.g., entropy encode) the vertex information of the first edge, for example, based on the context or probability model (e.g., the context or probability model selected at step 2008). The encoder may further send, in a bitstream, an indication of a size of the buffer array. The indication of the size of the buffer array may comprise an indication of a quantity (e.g., number) of buffer elements in the buffer array and a depth of each of the buffer elements in the buffer array. The indication of the size of the buffer array may comprise an indication of a codec profile or a codec level. The first buffer element index array may comprise a coder index array of a leaf-per-leaf tree and a quantity (e.g., number) of visits array of the leaf-per-leaf tree.

One or more method steps of flowchart 2000 may be used by an encoder to entropy encode an occupancy bit of an occupancy tree used to represent or code a point cloud as described herein. Additionally, or alternatively, one or more method steps of flowchart 2000 may be used by an encoder to entropy encode to vertex information of a TriSoup edge. The encoder may encode a point cloud frame by using the first occupancy bit or vertex information.

FIG. 20B shows an example method for decoding vertex information of a current edge. More specifically, FIG. 20B shows a flowchart 2020 of example method steps for decoding vertex information of a current edge. One or more steps of the example flowchart 2020 may be performed by decoder 120 as described herein with respect to FIG. 1.

At step 2022, a decoder may determine a neighborhood configuration of a first edge (or a first TriSoup edge) of a TriSoup node of a point cloud. The neighborhood configuration may be determined, for example, based on already-coded presence flags and positions (of present TriSoup vertices) of TriSoup edges. The neighborhood configuration may correspond to configuration β described herein with respect to FIG. 15, FIG. 16, FIG. 17 and FIG. 18.

At step 2024, a decoder may index a first buffer element index array. The decoder may index a first buffer element index array based on a quantity (e.g., number) of symbols of a first part of the neighborhood configuration that are masked. The decoder may index a first buffer element index array based on the first part of the neighborhood configuration to determine a first index for a range of coder indices in a buffer array. With respect to the description of FIG. 15, FIG. 16, FIG. 17 and FIG. 18 herein, the first part of the neighborhood configuration may correspond to βₗₚₗ, the quantity (e.g., number) of symbols of the first part of the neighborhood configuration that are masked may correspond to kₗₚₗ[βₗₚₗ], the first buffer element index array may correspond to buffElemIdx[] (or the concatenation of values in arrays NVₗₚₗ[ ] and IDXₗₚₗ[]), the first index may correspond to Bidx, and the buffer array may correspond to either the one-dimensional version of array IDX_{B}[] or the two-dimensional version of array IDX_{B}[][].

A first buffer element index array may be indexed, for example, based on the quantity (e.g., number) of symbols of the first part of the neighborhood configuration that are masked being equal to zero. A buffer array may be a one-dimensional array and the index for the range of coder indices may indicate a starting location of the range of coder indices in the buffer array. The buffer array may be a two-dimensional array and indexing the buffer array, to determine the coder index, may comprise indexing: a first dimension of the buffer array using the first index for the range of coder indices; and a second dimension of the buffer array using the second part of the neighborhood configuration. The memory associated with the range of coder indices may be a buffer element (e.g., buffer element 1550 as described herein with respect to FIG. 15) of the buffer array.

A first index for the range of coder indices in the buffer array may be determined based on a global variable that is incremented. The global variable may be incremented, for example, after a buffer element of the buffer array is attached to a leaf node of an OBUF instance. The global variable may be re-initialized to a starting value, for example, if the global variable is incremented a quantity (e.g., number) of times. The quantity (e.g., number) of times that the global variable is incremented may be equal to a quantity (e.g., number) of buffer elements in the buffer array. The starting value may be zero. The global variable may correspond to lastBidx as described herein with respect to FIG. 15, FIG. 16, FIG. 17 and FIG. 18.

A first index for the range of coder indices in the buffer array may be determined. A first index for the range of coder indices in the buffer array may be determined, for example, after the global variable is re-initialized to a starting value. A first index for the range of coder indices in the buffer array may be determined, for example, based on a distance of a first coder index to a second coder index. The first coder index may be associated with the first part of the neighborhood configuration. The second coder index may be stored in a buffer element of the buffer array at an index associated with the second part of the neighborhood configuration. The second coder index may be determined to have a smallest distance to the first coder index among coder indices of a plurality of buffer elements, of the buffer array, associated with the second part of the neighborhood configuration. The quantity (e.g., number) of the plurality of buffer elements may be determined, for example, based on a search range size. The search range size may be sent (e.g., transmitted) by the encoder over a bitstream and/or received by the decoder from the bitstream.

At step 2026, a decoder may index the buffer array. The decoder may index the buffer array to determine a coder index. The decoder may index the buffer array to determine a coder index based on: the first index for the range of coder indices; and a second part of the neighborhood configuration. With respect to FIGS. 15-18 described herein, the second part of the neighborhood configuration may correspond to β_{buff} and the code index may correspond to either idx=IDX_{B}[(Bidx<<d_{buff})+β_{buff}] or idx=IDX_{B}[Bidx][β_{buff}].

At step 2028, a decoder may select a context or probability model for coding vertex information of the first edge. The decoder may select a context or probability model for coding vertex information of the first edge, for example, based on the coder index.

At step 2030, a decoder may code (e.g., entropy decode) the vertex information of the first edge. The decoder may code (e.g., entropy decode) the vertex information of the first edge, for example, based on the context or probability model (e.g., the context or probability model selected at step 2008). The decoder may further send and/or receive, in a bitstream, an indication of a size of the buffer array. The indication of the size of the buffer array may comprise an indication of a quantity (e.g., number) of buffer elements in the buffer array and a depth of each of the buffer elements in the buffer array. The indication of the size of the buffer array may comprise an indication of a codec profile or a codec level. The first buffer element index array may comprise a coder index array of a leaf-per-leaf tree and a quantity (e.g., number) of visits array of the leaf-per-leaf tree.

One or more method steps of flowchart 2000 may be used by a decoder to entropy code (e.g., decode) an occupancy bit of an occupancy tree used to represent or code a point cloud as described herein. Additionally, or alternatively, one or more method steps of flowchart 2000 may be used by a decoder to entropy decode to vertex information of a TriSoup edge. The decoder may decode a point cloud frame by using the first occupancy bit or vertex information.

FIG. 21 shows an example computer system in which examples of the present disclosure may be implemented. For example, the example computer system 2100 shown in FIG. 21 may implement one or more of the methods described herein. For example, various devices and/or systems described herein (e.g., in FIGS. 1, 2, and 3) may be implemented in the form of one or more computer systems 2100. Furthermore, each of the steps of the flowcharts depicted in this disclosure may be implemented on one or more computer systems 2100.

Computer system 2100 may comprise one or more processors, such as a processor 2104. Processor 2104 may be a special purpose processor, a general purpose processor, a microprocessor, and/or a digital signal processor. Processor 2104 may be connected to a communication infrastructure 2102 (e.g., a bus or network). Computer system 2100 may also comprise a main memory 2106 (e.g., a random access memory (RAM)) and/or a secondary memory 2108.

Secondary memory 2108 may comprise a hard disk drive 2110 and/or a removable storage drive 2112 (e.g., a magnetic tape drive, an optical disc drive, and/or the like). Removable storage drive 2112 may read from and/or write to a removable storage unit 2116. Removable storage unit 2116 may comprise a magnetic tape, optical disc, and/or the like. Removable storage unit 2116 may be read by and/or may be written to removable storage drive 2112. Removable storage unit 2116 may comprise a computer usable storage medium having stored therein computer software and/or data.

Secondary memory 2108 may comprise other similar means for allowing computer programs or other instructions to be loaded into computer system 2100. Such means may include a removable storage unit 2118 and/or an interface 2114. Examples of such means may comprise a program cartridge and/or cartridge interface (such as in video game devices), a removable memory chip (e.g., an erasable programmable read-only memory (EPROM) or a programmable read-only memory (PROM)) and associated socket, a thumb drive and Universal Serial Bus (USB) port, and/or other removable storage units 2118 and interfaces 2114, which may allow software/or and data to be transferred from removable storage unit 2118 to computer system 2100.

Computer system 2100 may comprise a communications interface 2120. Communications interface 2120 may allow software and data to be transferred between computer system 2100 and external device(s). Examples of communications interface 2120 may include a modem, a network interface (e.g., an Ethernet card), a communications port, etc. Software and/or data transferred via communications interface 2120 may be in the form of signals which may be electronic, electromagnetic, optical, and/or other signals capable of being received by communications interface 2120. The signals may be provided to communications interface 2120 via a communications path 2122. Communications path 2122 may carry signals and may be implemented using wire or cable, fiber optics, a phone line, a cellular phone link, a radio frequency (RF) link, and/or other communications channels.

Computer system 2100 may include one or more sensor(s) 2124. Sensor(s) 2124 may measure and/or detect one or more physical quantities. Sensor(s) 2124 may convert the measured or detected physical quantities into an electrical signal in digital and/or analog form. For example, sensor(s) 2124 may include an eye tracking sensor to track the eye movement of a user. Based on the eye movement of a user, a display of a point cloud may be updated. In another example, sensor(s) 2124 may include a head tracking sensor (e.g., a gyroscope) to track the head movement of a user. Based on the head movement of a user, a display of a point cloud may be updated. In yet another example, sensor(s) 2124 may include a camera sensor for taking photographs and/or a 3D scanning device (e.g., a laser scanning, structured light scanning, and/or modulated light scanning device). 3D scanning devices may obtain geometry information by moving one or more laser heads, structured light, and/or modulated light cameras relative to the object or scene being scanned. The geometry information may be used to construct a point cloud.

A computer program medium and/or a computer-readable medium may be used to refer to tangible (e.g., non-transitory) storage media, such as removable storage units 2116 and 2118 or a hard disk installed in hard disk drive 2110. These computer program products may be means for providing software to computer system 2100. Computer programs (also referred to as computer control logic) may be stored in main memory 2106 and/or secondary memory 2108. The computer programs may be received via communications interface 2120. Such computer programs, when executed, may enable the computer system 2100 to implement one or more example embodiments of the present disclosure as discussed herein. In particular, the computer programs, when executed, may enable processor 2104 to implement the processes of the present disclosure, such as any of the methods described herein. Accordingly, such computer programs may represent controllers of computer system 2100.

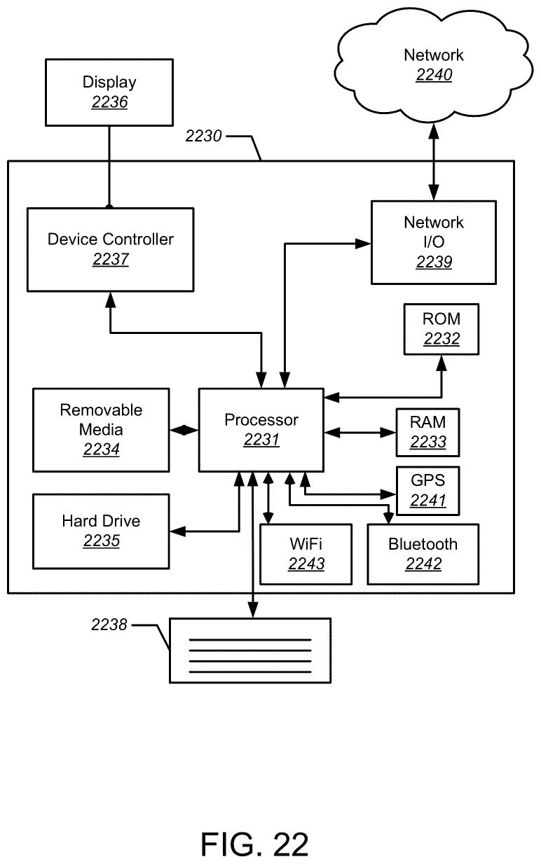

FIG. 22 shows example elements of a computing device that may be used to implement any of the various devices described herein, including, for example, a source device (e.g., 102), an encoder (e.g., 114), a destination device (e.g., 106), a decoder (e.g., 120), and/or any computing device described herein. The computing device 2230 may include one or more processors 2231, which may execute instructions stored in the random-access memory (RAM) 2233, the removable media 2234 (e.g., a Universal Serial Bus (USB) drive, compact disc (CD) or digital versatile disc (DVD), or floppy disk drive), or any other desired storage medium. Instructions may also be stored in an attached (or internal) hard drive 2235. The computing device 2230 may also include a security processor (not shown), which may execute instructions of one or more computer programs to monitor the processes executing on the processor 2231 and any process that requests access to any hardware and/or software components of the computing device 2230 (e.g., ROM 2232, RAM 2233, the removable media 2234, the hard drive 2235, the device controller 2237, a network interface 2239, a GPS 2241, a Bluetooth interface 2242, a Wi-Fi interface 2243, etc.). The computing device 2230 may include one or more output devices, such as the display 2236 (e.g., a screen, a display device, a monitor, a television, etc.), and may include one or more output device controllers 2237, such as a video processor. There may also be one or more user input devices 2238, such as a remote control, keyboard, mouse, touch screen, microphone, etc. The computing device 2230 may also include one or more network interfaces, such as a network interface 2239, which may be a wired interface, a wireless interface, or a combination of the two. The network interface 2239 may provide an interface for the computing device 2230 to communicate with a network 2240 (e.g., a RAN, or any other network). The network interface 2239 may include a modem (e.g., a cable modem), and the external network 2240 may include communication links, an external network, an in-home network, a provider's wireless, coaxial, fiber, or hybrid fiber/coaxial distribution system (e.g., a DOCSIS network), or any other desired network. Additionally, the computing device 2230 may include a location-detecting device, such as a global positioning system (GPS) microprocessor 2241, which may be configured to receive and process global positioning signals and determine, with possible assistance from an external server and antenna, a geographic position of the computing device 2230.

The example in FIG. 22 may be a hardware configuration, although the components shown may be implemented as software as well. Modifications may be made to add, remove, combine, divide, etc. components of the computing device 2230 as desired. Additionally, the components may be implemented using basic computing devices and components, and the same components (e.g., processor 2231, ROM storage 2232, display 2236, etc.) may be used to implement any of the other computing devices and components described herein. For example, the various components described herein may be implemented using computing devices having components such as a processor executing computer-executable instructions stored on a computer-readable medium, as shown in FIG. 22. Some or all of the entities described herein may be software based, and may co-exist in a common physical platform (e.g., a requesting entity may be a separate software process and program from a dependent entity, both of which may be executed as software on a common computing device).

A computing device may perform a method comprising multiple operations. The computing device may determine a neighborhood configuration of a first occupancy bit indicating an occupancy of a sub-cuboid associated with a point cloud frame. The computing device may, based on a quantity of symbols of a first part of the neighborhood configuration, index a first buffer element index array using the first part of the neighborhood configuration to determine a first index associated with a range of coder indices in a buffer array; may index the buffer array, to determine a coder index, based on: the first index associated with the range of coder indices; and a second part of the neighborhood configuration; and based on a context associated with the coder index, may decode the first occupancy bit. The computing device may decode, using the first occupancy bit, a point cloud frame. The computing device may index the first buffer element index array based on the quantity of symbols of the first part of the neighborhood configuration being equal to zero, wherein the index associated with the range of coder indices indicates a starting location of the range of coder indices in the buffer array; wherein the buffer array may be a two-dimensional array and wherein indexing the buffer array may further comprise: using the first index for the range of coder indices to index a first dimension of the buffer array; and using the second part of the neighborhood configuration to index a second dimension of the buffer array; wherein a buffer element of the buffer array may comprise memory associated with the range of coder indices. The computing device may receive, in a bitstream, an indication of a size of the buffer array, wherein the indication of the size of the buffer array may comprise an indication of: a quantity of buffer elements in the buffer array; and a depth of each of the buffer elements in the buffer array; wherein the indication of the size of the buffer array may comprise an indication of a codec profile or a codec level, wherein the first buffer element index array may comprise: a coder index array of a leaf-per-leaf tree; and a quantity of visits array of the leaf-per-leaf tree; wherein the first index and the second index may be the same; wherein the first buffer element index array may be for a first Optimal Binary Coders with Update on the Fly (OBUF) instance and the second buffer element index array may be for a second OBUF instance that may be different from the first OBUF instance; wherein a starting value may be zero; wherein a second coder index may be determined to have a smallest distance to the first coder index among coder indices of a plurality of buffer elements of the buffer array associated with the second part of the neighborhood configuration; wherein a quantity of the plurality of buffer elements may be determined based on a search range size; wherein the search range size may be sent/received over a bitstream; wherein the vertex information of the first edge may comprise a vertex presence flag of the first edge; wherein the vertex information of the first edge may comprise a vertex position of the first edge; wherein a buffer element of the buffer array may comprise memory associated with the range of coder indices. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode the first occupancy bit based on a context associated with the coder index. A computer-readable medium may store instructions that, when executed, cause performance of the described method, additional operations and/or include the additional elements.

A computing device may perform a method comprising multiple operations. The computing device may determine a neighborhood configuration of a first edge indicating an occupancy of a sub-cuboid associated with a point cloud frame. The computing device may, based on a quantity of symbols of a first part of the neighborhood configuration, index a first buffer element index array using the first part of the neighborhood configuration to determine a first index associated with a range of coder indices in a buffer array. The computing device may index the buffer array, to determine a coder index, based on: the first index associated the range of coder indices; and a second part of the neighborhood configuration; and based on a context associated with the coder index, may decode vertex information of the first edge. The computing device may decode, using the vertex information, a point cloud frame. The computing device may determine a neighborhood configuration of a second edge; and based on a quantity of symbols of a first part of the neighborhood configuration of the second edge, may index the first buffer element index array using the first part of the neighborhood configuration of the second edge to determine a second index associated with a range of coder indices in the buffer array, wherein the first index and the second index may be the same; wherein the first buffer element index array may be for a first Optimal Binary Coders with Update on the Fly (OBUF) instance. The computing device may determine the first index, associated with the range of coder indices in the buffer array is determined, based on a global variable, wherein the global variable may be incremented after a buffer element of the buffer array is attached to a leaf node of an Optimal Binary Coders with Update on the Fly (OBUF) instance. The computing device may set the global variable to a starting value after the global variable is incremented a quantity of times equal to a quantity of buffer elements in the buffer array. The computing device may determine the first index, associated with the range of coder indices in the buffer array, based on a distance of a first coder index, associated with the first part of the neighborhood configuration, to a second coder index stored in a buffer element of the buffer array at an index associated with the second part of the neighborhood configuration, wherein the first index and the second index may be the same; wherein the first buffer element index array may be for a first Optimal Binary Coders with Update on the Fly (OBUF) instance and the second buffer element index array may be for a second OBUF instance that may be different from the first OBUF instance; wherein a starting value may be zero; wherein a second coder index may be determined to have a smallest distance to the first coder index among coder indices of a plurality of buffer elements of the buffer array associated with the second part of the neighborhood configuration; wherein a quantity of the plurality of buffer elements may be determined based on a search range size; wherein the search range size may be sent/received over a bitstream; wherein the vertex information of the first edge may comprise a vertex presence flag of the first edge; wherein the vertex information of the first edge may comprise a vertex position of the first edge; wherein a buffer element of the buffer array comprises memory associated with the range of coder indices. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to encode the first occupancy bit based on a context associated with the coder index. A computer-readable medium may store instructions that, when executed, cause performance of the described method, additional operations and/or include the additional elements.

A computing device may perform a method comprising multiple operations. The computing device may determine a neighborhood configuration indicating an occupancy of a sub-cuboid associated with a point cloud frame. The computing device may, based on a quantity of symbols of a first part of the neighborhood configuration, index a first buffer element index array using the first part of the neighborhood configuration to determine a first index associated with a range of coder indices in a buffer array; may index the buffer array, to determine a coder index, based on: the first index associated with the range of coder indices; and a second part of the neighborhood configuration; and based on a context associated with the coder index, may encode the first occupancy bit. The computing device may encode, using the first occupancy bit, a point cloud frame, wherein determining the neighborhood configuration may further comprise: determining the neighborhood configuration of a first occupancy bit, wherein determining the neighborhood configuration may further comprise: determining the neighborhood configuration of a first edge. The computing device may determine a neighborhood configuration of a second edge; and based on a quantity of symbols of a first part of the neighborhood configuration of the second edge, may index a second buffer element index array using the first part of the neighborhood configuration of the second edge to determine a second index for a range of coder indices in the buffer array; wherein the first index and the second index may be the same; wherein the first buffer element index array may be for a first Optimal Binary Coders with Update on the Fly (OBUF) instance and the second buffer element index array may be for a second OBUF instance that may be different from the first OBUF instance, wherein a starting value may be zero; wherein a second coder index may be determined to have a smallest distance to the first coder index among coder indices of a plurality of buffer elements of the buffer array associated with the second part of the neighborhood configuration; wherein a quantity of the plurality of buffer elements may be determined based on a search range size; wherein the search range size may be sent/received over a bitstream; wherein the vertex information of the first edge may comprise a vertex presence flag of the first edge; wherein the vertex information of the first edge may comprise a vertex position of the first edge. wherein a buffer element of the buffer array comprises memory associated with the range of coder indices. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to decode the first occupancy bit based on a context associated with the coder index. A computer-readable medium may store instructions that, when executed, cause performance of the described method, additional operations and/or include the additional elements.

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated if its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof. If implemented in software, firmware, middleware or microcode, the program code or code segments to perform the necessary tasks (e.g., a computer-program product) may be stored in a computer-readable or machine-readable medium. A processor(s) may perform the necessary tasks. Features of the present disclosure may be implemented in hardware using, for example, hardware components such as application-specific integrated circuits (ASICs) and gate arrays. Implementation of a hardware state machine to perform the functions described herein will also be apparent to persons skilled in the art.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disc, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein. Computer-readable medium may comprise, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

A non-transitory tangible computer readable media may comprise instructions executable by one or more processors configured to cause operations described herein. An article of manufacture may comprise a non-transitory tangible computer readable machine-accessible medium having instructions encoded thereon for enabling programmable hardware to cause a device (e.g., an encoder, a decoder, a transmitter, a receiver, and the like) to allow operations described herein. The device, or one or more devices such as in a system, may include one or more processors, memory, interfaces, and/or the like.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more of the operations described herein may be conditional. For example, one or more operations may be performed if certain criteria are met, such as in computing device, a communication device, an encoder, a decoder, a network, a combination of the above, and/or the like. Example criteria may be based on one or more conditions such as device configurations, traffic load, initial system set up, packet sizes, traffic characteristics, a combination of the above, and/or the like. If the one or more criteria are met, various examples may be used. It may be possible to implement any portion of the examples described herein in any order and based on any condition.

Although examples are described herein, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
determining a neighborhood configuration of a first occupancy bit indicating an occupancy of a sub-cuboid associated with a point cloud frame;
based on a quantity of symbols of a first part of the neighborhood configuration, indexing a first buffer element index array using the first part of the neighborhood configuration to determine a first index associated with a range of coder indices in a buffer array;
indexing the buffer array, to determine a coder index, based on:
the first index associated with the range of coder indices; and
a second part of the neighborhood configuration; and
based on a context associated with the coder index, decoding the first occupancy bit.

2. The method of claim 1, further comprising decoding, using the first occupancy bit, the point cloud frame.

3. The method of claim 1, further comprising:
indexing the first buffer element index array based on the quantity of symbols of the first part of the neighborhood configuration being equal to zero.

4. The method of claim 1, wherein the index associated with the range of coder indices indicates a starting location of the range of coder indices in the buffer array.

5. The method of claim 1, wherein the buffer array is a two-dimensional array and wherein indexing the buffer array further comprises:
using the first index for the range of coder indices to index a first dimension of the buffer array; and
using the second part of the neighborhood configuration to index a second dimension of the buffer array.

6. The method of claim 1, further comprising:
receiving, in a bitstream, an indication of a size of the buffer array.

7. The method of claim 6, wherein the indication of the size of the buffer array comprises an indication of:
a quantity of buffer elements in the buffer array; and
a depth of each of the buffer elements in the buffer array.

8. The method of claim 6, wherein the indication of the size of the buffer array comprises an indication of a codec profile or a codec level.

9. The method of claim 1, wherein the first buffer element index array comprises:
a coder index array of a leaf-per-leaf tree; and
a quantity of visits array of the leaf-per-leaf tree.

10. A method comprising:
determining a neighborhood configuration of a first edge indicating an occupancy of a sub-cuboid associated with a point cloud frame;
based on a quantity of symbols of a first part of the neighborhood configuration, indexing a first buffer element index array using the first part of the neighborhood configuration to determine a first index associated with a range of coder indices in a buffer array;
indexing the buffer array, to determine a coder index, based on:
the first index associated the range of coder indices; and
a second part of the neighborhood configuration; and
based on a context associated with the coder index, decoding vertex information of the first edge.

11. The method of claim 10, further comprising:
determining a neighborhood configuration of a second edge; and
based on a quantity of symbols of a first part of the neighborhood configuration of the second edge, indexing the first buffer element index array using the first part of the neighborhood configuration of the second edge to determine a second index associated with a range of coder indices in the buffer array.

12. The method of claim 11, wherein the first index and the second index are the same.

13. The method of claim 10, wherein the first buffer element index array is for a first Optimal Binary Coders with Update on the Fly (OBUF) instance.

14. The method of claim 10, further comprising:
determining the first index, associated with the range of coder indices in the buffer array is determined, based on a global variable, wherein the global variable is incremented after a buffer element of the buffer array is attached to a leaf node of an Optimal Binary Coders with Update on the Fly (OBUF) instance.

15. The method of claim 14, further comprising:
setting the global variable to a starting value after the global variable is incremented a quantity of times equal to a quantity of buffer elements in the buffer array.

16. The method of claim 10, further comprising:
determining the first index, associated with the range of coder indices in the buffer array, based on a distance of a first coder index, associated with the first part of the neighborhood configuration, to a second coder index stored in a buffer element of the buffer array at an index associated with the second part of the neighborhood configuration.

17. A method comprising:
determining a neighborhood configuration indicating an occupancy of a sub-cuboid associated with a point cloud frame;
based on a quantity of symbols of a first part of the neighborhood configuration, indexing a first buffer element index array using the first part of the neighborhood configuration to determine a first index associated with a range of coder indices in a buffer array;
indexing the buffer array, to determine a coder index, based on:
the first index associated with the range of coder indices; and
a second part of the neighborhood configuration; and
based on a context associated with the coder index, encoding the first occupancy bit.

18. The method of claim 17, wherein determining the neighborhood configuration further comprising:
determining the neighborhood configuration of a first occupancy bit.

19. The method of claim 17, wherein determining the neighborhood configuration further comprising:
determining the neighborhood configuration of a first edge.

20. The method of claim 19, further comprising:
determining a neighborhood configuration of a second edge; and
based on a quantity of symbols of a first part of the neighborhood configuration of the second edge, indexing a second buffer element index array using the first part of the neighborhood configuration of the second edge to determine a second index for a range of coder indices in the buffer array.
